(19) United States
(12) Patent Application Publication
(10) Pub. No.: US 2026/0303613 A1
(43) Pub. Date: Oct. 1, 2026

(54) DYNAMIC EVENT-BASED ACCESS CONTROLS

(71) Applicant: RAY RESEARCH, LTD., Ramat Gan (IL)

(72) Inventors: Ariel ZAMIR, Kibbutz Ramot Menashe (IL); Eric WOLF, Tel Aviv (IL); Dekel LEVKOVITCH, Savyon (IL)

(21) Appl. No.: 19/631,112

(22) Filed: Mar. 27, 2026

Related U.S. Application Data
(60) Provisional application No. 63/780,571, filed on Mar. 31, 2025.

(51) Int. Cl. H04L 9/40

(52) U.S. Cl. CPC H04L 63/108; H04L 63/1441

(57) ABSTRACT

A method to dynamically adjust access controls in a distributed computer system. An access monitoring module monitors access requests by a plurality of entities to detect an access event. An access event analysis module determines access event attributes, including entity identification attributes, data object attributes, and a predicted activity status generated by a trained machine-learning prediction model trained on a forensic-scan-derived feature vector. An access event scoring module calculates a weighted composite access event score. A remedial action module automatically performs one or more remedial actions when the score exceeds a predefined threshold, the remedial actions including at least one technical modification to (i) an authentication method applicable to the entity or (ii) access controls or storage configuration of one or more data objects in the distributed storage nodes.

### CROSS-REFERENCE TO RELATED APPLICATIONS

This application claims the benefit of priority from U.S. Provisional Patent Application No. 63/780,571, filed Mar. 31, 2025, entitled “DYNAMIC EVENT-BASED ACCESS CONTROLS,” the contents of which are all incorporated by reference as if fully set forth herein in their entirety.

### FIELD OF THE INVENTION

This invention relates to the field of network and computer security, and specifically, electronic authentication of user identity to gain access to information systems.

### BACKGROUND

Authentication is the process of verifying user identity prior to the user accessing an information system, such as a computer network. Authentication takes place when a user attempts to log into a computer system resource (such as a computer network, device, or application). The computer resource then requires the user to supply specific information in order to verify the authenticity of the user. Simple authentication typically requires the user to only provide one piece of information, known as ‘single factor’ authentication. This single piece of information may be password, ID number, or PIN. By supplying this information, the computer system receives proof that the user is in possession of this information.

In some cases, the computer system may implement stricter authentication protocols, for enhanced security purposes. In such cases, the computer system may require two or more authentication factors to be supplied by the user. Additional factors may include proof of possession of a specific device, such as a mobile phone, PC, or security token. Other options include user biometric factors, such as fingerprints, facial recognition, eye scan, or voice pattern.

However, enhanced security measures, such as MFA, also have drawbacks. One of the main disadvantages of MFA is the added complexity it introduces to the login process. Users must remember and manage multiple authentication factors, which can be frustrating and time-consuming. MFA also typically results in increased login time, because users must go through one or more additional steps to login into a system. Furthermore, if users lose access to one of their authentication factors (e.g., losing their smartphone or security token), they may be temporarily locked out of their accounts. This can lead to productivity loss and increased support requests. All this may lead to user resistance to the adoption of MFA and similar protocols, due to the perceived inconvenience and added complexity. For organizations, implementing MFA can involve significant costs, including purchasing hardware tokens, software licenses and training employees on new security protocols. Accordingly, many organizations limit the use of MFA to the most sensitive information and resources, so as not to overburden users who require ongoing access to the data and applications. However, this leaves large swaths of data objects in enterprise computing systems with only weak protection against possible intrusion by malicious actors.

Some systems also include risk-based or adaptive authentication, wherein authentication requirements are adjusted based on risk signals, or user and entity behavior analytics (UEBA), which perform behavioral analysis based on user behavior. Other systems may implement zero trust architecture, which requires continuous verification, or data loss prevention (DLP) approaches which monitor data access. However, these approaches are generally reactive and do not incorporate predictive capabilities with respect to user activity.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a computer-implemented method for dynamically adjusting access controls in a computer system, the method comprising: monitoring, by an access monitoring module executing on one or more processors, access requests by a plurality of entities in a target computer system comprising a plurality of data objects stored across one or more storage nodes, to detect an access event initiated by an entity; analyzing, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window; calculating, by an access event scoring module executing on the one or more processors, an access event score for the detected access event as a weighted combination of a plurality of sub-scores, each sub-score corresponding to one or more of the set of access event attribute categories, wherein the access event score represents a significance level of the access event; and automatically performing, by a remedial action module executing on the one or more processors, one or more remedial actions based on the access event score, wherein the remedial actions include at least one technical modification to (i) an authentication method applicable to the entity, or (ii) access controls or storage configuration of one or more data objects in the distributed storage nodes.

There is also provided, in an embodiment, a system comprising at least one hardware processor; and a non-transitory computer-readable storage medium having stored thereon program instructions, the program instructions executable by the at least one hardware processor to: monitor, by an access monitoring module executing on one or more processors, access requests by a plurality of entities in a target computer system comprising a plurality of data objects stored across one or more storage nodes, to detect an access event initiated by an entity, analyze, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window, calculate, by an access event scoring module executing on the one or more processors, an access event score for the detected access event as a weighted combination of a plurality of sub-scores, each sub-score corresponding to one or more of the set of access event attribute categories, wherein the access event score represents a significance level of the access event, and automatically perform, by a remedial action module executing on the one or more processors, one or more remedial actions based on the access event score, wherein the remedial actions include at least one technical modification to (i) an authentication method applicable to the entity, or (ii) access controls or storage configuration of one or more data objects in the distributed storage nodes.

There is further provided, in an embodiment, a computer program product comprising a non-transitory computer-readable storage medium having program instructions embodied therewith, the program instructions executable by at least one hardware processor to: monitor, by an access monitoring module executing on one or more processors, access requests by a plurality of entities in a target computer system comprising a plurality of data objects stored across one or more storage nodes, to detect an access event initiated by an entity; analyze, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window; calculate, by an access event scoring module executing on the one or more processors, an access event score for the detected access event as a weighted combination of a plurality of sub-scores, each sub-score corresponding to one or more of the set of access event attribute categories, wherein the access event score represents a significance level of the access event; and automatically perform, by a remedial action module executing on the one or more processors, one or more remedial actions based on the access event score, wherein the remedial actions include at least one technical modification to (i) an authentication method applicable to the entity, or (ii) access controls or storage configuration of one or more data objects in the distributed storage nodes.

In some embodiments, the machine-learning prediction model is trained on a training dataset comprising, for each of a plurality of data objects in the target computer system, (i) a feature vector derived from metadata collected in a forensic scan of the target computer system, and (ii) a ground-truth label indicating an observed activity status of the data object within a predefined time window, wherein the trained machine-learning prediction model is periodically retrained based on updated metadata.

In some embodiments, the predicted activity status comprises one of the following activity-status classes: active, indicating the data object is likely to be accessed on a read, write, or modify basis within the predefined time window; inactive, indicating the data object is unlikely to be accessed within the predefined time window; read-only, indicating the data object is likely to be accessed on a read-only basis only within the predefined time window; or routine maintenance, indicating the data object is likely to be accessed only for periodic or routine system maintenance within the predefined time window

In some embodiments, detecting the access event comprises evaluating the access requests against one or more configurable detection rules, the detection rules comprising at least one of: a threshold condition based on a number of access requests within a specified time window; a scope condition based on the entity requesting access to data objects outside the entity's typical access scope; a temporal condition based on the time-related attributes of the access requests; a sensitivity condition based on the sensitivity or confidentiality attributes of the data objects associated with the access requests; a velocity condition based on a rate of access requests exceeding a baseline rate derived from the entity's historical access profile; a geographic condition based on the access requests originating from a geographic location inconsistent with the entity's known location; or a cross-boundary condition based on the access requests spanning multiple storage nodes, geographic regions, or tenant boundaries.

In some embodiments, detecting the access event comprises applying a trained machine-learning detection model to incoming access request data, the machine-learning detection model trained on historical access request data labeled with indicators of whether corresponding access requests were associated with a security incident, an anomalous access pattern, or a policy violation, wherein the machine-learning detection model outputs a probability or classification indicating whether the access requests constitute an access event.

In some embodiments, the remedial actions are selected from a plurality of remedial action levels, each remedial action level associated with a respective access event score range.

In some embodiments, the remedial actions comprise at least one of: (i) quarantining one or more data objects into a secure dedicated storage cache, (ii) designating one or more data objects as read-only, (iii) modifying the authentication assurance level associated with the entity representing a degree of confidence that the entity is an entity to which presented credentials were issued, (iv) modifying the authentication method applicable to the entity to include one or more additional authentication factors, (v) restricting access by the entity to one or more data objects, or (vi) suspending the entity's session.

In some embodiments, the set of access event attribute categories further comprises one or more of the following access event attribute categories: entity access and usage history attributes, access event time-based attributes, access event scope attributes, and behavioral deviation metrics quantifying a degree of deviation of the access event from a historical usage profile of the entity.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1A depicts an exemplary distributed computing system.

FIG. 1B illustrates an exemplary distributed storage model which may be used in conjunction with a distributed computer environment.

FIG. 2A is a block diagram of an exemplary system for applying dynamic access controls in a computer system, based on analyzing access-events involving data objects in the computer system.

FIG. 2B depicts an exemplary realization of the system shown in FIG. 2A.

FIG. 3 illustrates the functional steps in a method for applying dynamic access controls in a computer system, based on analyzing access-events involving data objects in the computer system.

FIG. 4 is a flowchart which illustrates an access event scoring algorithm.

FIG. 5 illustrates the functional steps in a method for training and inferencing a prediction model configured to output a classification which indicates a predicted activity status with respect to each of data object in a distributed computer environment.

### DETAILED DESCRIPTION

Disclosed herein is a technique, embodied as a computer-implemented method, a system, and a computer program product, for dynamically applying access controls in a computer system, based on analyzing access-events involving data objects in the computer system.

The present technique provides a technological improvement to the functioning of distributed computer systems, by using a dedicated prediction model trained on system-wide metadata, to classify data objects in a distributed multi-node storage environment. The present technique further allows to dynamically monitor system access events by user entities, and to adjust controls in real time and apply technical remedial mechanisms (such as data object segregation and enforcement of enhanced access controls), based on the data object classification. The present technique thus solves a technical problem rooted in distributed storage, i.e., data object permission drift and large dormant-data attack surface, with a specific technical solution which reduces the attack surface and resource overhead.

In some embodiments, the present technique provides for applying dynamic implementation and/or modification of entity and/or data object access controls in a computer system, based on real-time analysis of an access-event by an entity. In some embodiments, an access-event by an entity may involve requesting access to, or attempting to access, one or more data objects in a computer system.

In some embodiments, an analysis of an access-event may be based on entity identity, entity access permissions, entity past access and usage patterns, a total number of data objects accessed, and/or specific attributes of the one or more data objects accessed.

In some embodiments, dynamic implementation and/or modification of data object access controls may comprise blocking or restricting the ability to access and/or modify one or more data objects. In some examples, this may comprise isolating, removing, quarantining, limiting access permissions, analyzing, and/or deactivating one or more of the data objects.

In some embodiments, dynamic implementation and/or modification of entity access controls may comprise restricting revoking, restricting, or modifying the access and login privileges of one or more entities. In some cases, dynamic implementation and/or modification of entity access controls may comprise modifying a level of authentication assurance associated with one or more entities, e.g., by requiring one or more additional authentication factors, e.g., two or more authentication factors.

For purposes of this disclosure, the term ‘data object’ (used interchangeably with ‘data item’ or ‘data asset’) refers broadly to any digital resource within a computing environment, including any files, file directories, user directories, databases, data storage or repositories, software programs or applications, websites, and the like. For purposes of this disclosure, ‘data object’ includes system resources, such as any constituent of a computing environment, including computer sub-systems, external computer systems, storage devices, end-devices, servers, network nodes, storage nodes, users, user groups, and the like.

The term ‘metadata,’ as used herein with reference to a data object, refers broadly to descriptive, structural, and administrative information associated with data objects in a computer system. Metadata may include, but is not limited to: system-generated metadata such as data object name, type, format, size, creation timestamp, last-modified timestamp, location within a storage infrastructure, and version or revision indicators; ownership and authorship metadata including owner, author, and principal contributors; access and usage metadata including access history, access frequency, identity of accessing entities, type of access (e.g., read, write, modify, delete), and access permissions; relational metadata such as associations with other data objects, data lineage or dependency information, and organizational or project-based groupings; and classification metadata such as sensitivity level, regulatory compliance tags, retention policy, and predicted activity status.

The term ‘entity’ or ‘user entity,’ as used herein, refers broadly to any entity, whether authorized or unauthorized, attempting to gain access into a computer system and/or to one or more data objects within the computer system. Such entity may include any human, organization, automated bot, hardware device (such as a mobile device), or software application, as well as any groups or combinations of such entities. An entity in the context herein may be an authorized user or an unauthorized actor with respect to a target computer system. Thus, for example, an entity may be an authorized user having legitimate rights to access and modify computer system resources. However, such an authorized user may nonetheless represent a threat of malicious behavior in certain times and under specific circumstances. In other cases, an entity may be a malicious actor attempting to gain access into a computer system and/or to one or more data objects within the computer system, or take part in any similar action that is intended to enable unauthorized use of, or otherwise cause damage to, the computer system or resources thereof, or software application (including, but not limited to, application programming interfaces (APIs), service accounts, and automated scripts or agents operating on behalf of other entities), as well as any groups or combinations of such entities. For purposes of this disclosure, the terms ‘entity’ and ‘user entity’ are used interchangeably, and neither term implies that the entity is necessarily a human user.

The term ‘access,’ as used herein, refers broadly to any action attempted or taken by an entity with respect to one or more data objects or system resources in a computer system. ‘Access’ may comprise an access request by an authorized user that is validly logged into the computer system, as well as attempts to gain access by a malicious or otherwise unauthorized actor. “Access” actions may include, but are not limited to, any request or attempt to retrieve, read, query, modify, edit, copy, move, erase, execute, export, receive, transmit, store, process, share, and/or authenticate against one or more data objects. The ‘access’ itself may include, but is not limited to, any request or attempt to retrieve, read, modify, edit, move, erase, receive, transmit, store, process, and/or share one or more data objects.

The term ‘access event,’ as used herein, refers broadly to one or more related access' actions taken or attempted by an entity with respect to one or more data objects in a computer system. An access event may comprise a single access action (e.g., a single request to read a file) or an aggregation of multiple access actions that are related by one or more of: temporal proximity (e.g., actions occurring within a defined time window), session association (e.g., actions taken during a continuous authenticated session), entity identity (e.g., actions taken by the same entity), or target commonality (e.g., actions directed at the same data object or category of data objects). An access event may occur during an active authenticated session or may involve an unauthorized actor attempting or performing one or more access actions. The term ‘session,’ as used herein, refers to a continuous period during which an entity maintains an authenticated connection to the computer system, beginning with a successful authentication or login event and ending with a logout, timeout, or disconnection.

The term ‘access event score,’ as used herein, refers to a computed value representing a level of significance or sensitivity associated with an access event, determined based on one or more access event attributes. The access event score may be represented as a numerical value on a defined scale, a binary classification, or a discrete categorical assessment.

The term ‘access event attributes,’ as used herein, refers to any characteristics, properties, or data points associated with or derived from an access event, including attributes of the entity, the data objects involved, the temporal context, the access scope, and the predicted activity status of the data objects.

The term ‘activity status,’ as used herein with respect to a data object, refers to a predicted classification of the likelihood and nature of future access to the data object within a specified time period, as determined by a prediction model or other classification mechanism.

The term ‘remedial action,’ as used herein, refers to any automated or semi-automated responsive measure taken by the system in response to an access event score exceeding one or more thresholds, including actions directed at data objects, actions directed at entities, and notification actions.

The term ‘level of assurance,’ as used herein, refers to the degree of confidence that a claimed identity presented during an authentication process corresponds to the actual identity of the presenting entity. A level of assurance may be increased by requiring additional or stronger authentication factors

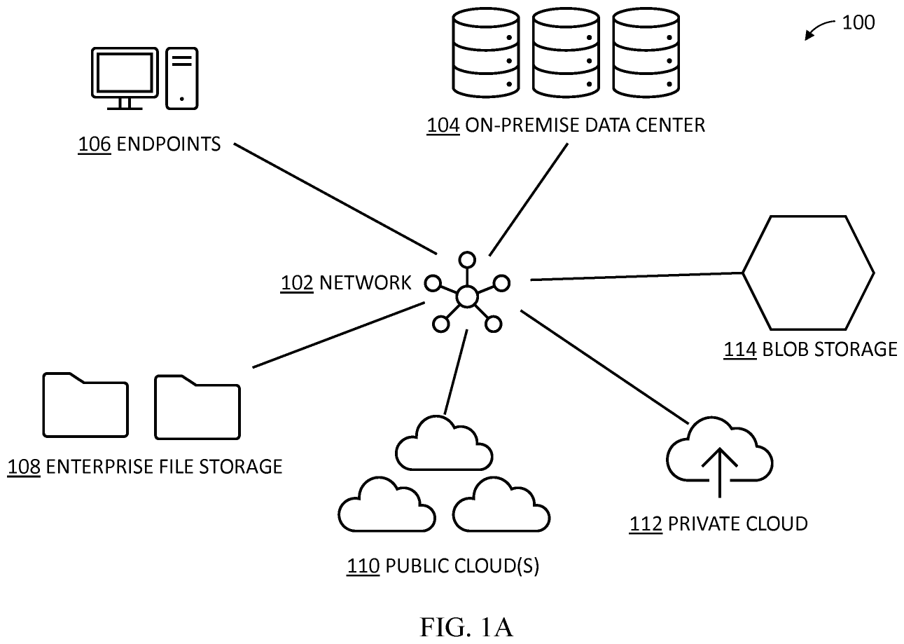

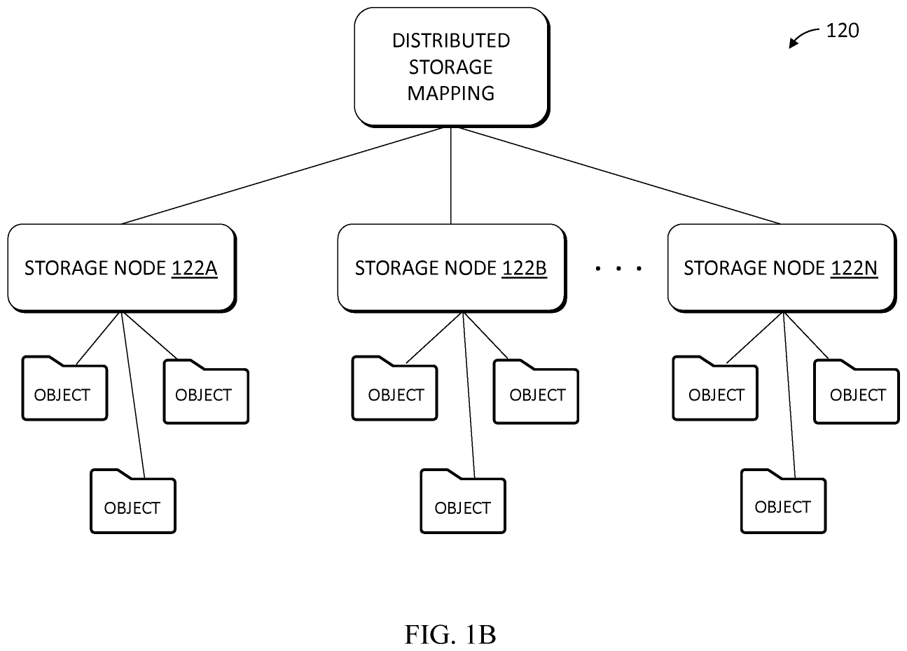

FIG. 1A depicts an exemplary computer system 100, in which the present technique for dynamically applying access controls in a computer system, based on analyzing access-events involving data objects in the computer system may be realized.

In some embodiments, computer system 100 may be any private, enterprise, governmental agency, healthcare facility, or similar computer system or environment. Computer system 100 may be any computing environment, including a distributed or decentralized computer system, a standalone computer system, a hybrid computing environment, a multi-cloud environment, or a multi-tenant computing environment. In some embodiments, the forensic scan of step 502 is performed by a data discovery module of system 200.

In some embodiments, computer system 100 comprises such elements as:
A network 102 which interconnects the various nodes of distributed computer system 100 and provides access to the stored data therein. Network 102 may comprise one or more interconnected private and public networks, including, but not limited to, a local area network (LAN), a virtual network, such as Microsoft Azure Virtual Network or similar, and/or the Internet.
An on-premise data center 104.
One or more endpoints 106, such as workstations, laptops, and mobile devices.
Enterprise file storage 108.
One or more public clouds 110.
A private cloud 112.
A blob storage 114.

However, in other cases, computer system 100 may comprise fewer, additional, and/or other different components and elements.

In some embodiments, distributed computer system 100 may comprise a distributed model, such as exemplary distributed storage model 120 illustrated in FIG. 1B. Distributed storage 120 may be organized as an arbitrary plurality of storage nodes 122A-122N accessible to users of distributed computer system 100 according to a configurable data access plan. Each storage node 122 may in turn be configured to store an arbitrary plurality of data objects.

In some embodiments, computer system 100 is a distributed or decentralized computer system, where data objects are stored or reside in more than one location or node, including proprietary on-premise and remote data centers, private cloud, and/or public cloud and similar platforms. In some cases, distributed storage 120 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding schema, such that the object data may be recreated from all or some of the generated portions, wherein the generated data object portions may be stored respectively in one or more storage nodes 122A-122N.

In some embodiments, distributed storage 120 may generate and store a mapping between data objects and storage nodes 122A-122N, which identifies a location of each data object within the plurality of storage nodes 122A-122N.

In some embodiments, computer system 100 may comprise one or more of the following categories of nodes and platforms:
Traditional Network-Attached Storage and File Servers: These provide block-level or file-level storage over network file protocols, designed for shared file access. Examples include NetApp Filer, Windows File Server, and AWS EFS.
Object Storage: Immutable key-value stores accessed via REST/HTTPS. No hierarchy beyond prefixes. Examples include S3 Bucket, Azure Blob Storage, and Amazon Glacier.
Cloud Data Warehouse: Serverless, columnar data warehouse, such as Snowflake.
Relational Databases: Open-source row/columnar relational databases, such as PostgreSQL.
Enterprise Content Management: Document-centric storage includes document libraries, versioning, metadata, and personal cloud file sync and share. Examples include SharePoint, Office 365, and OneDrive.
Unified Storage Arrays: Such as Dell EMC.
Endpoint Detection and Response (EDR): Cloud-native EDR platform, such as CrowdStrike Falcon.

As noted above, enterprises handling data via a distributed computer system (e.g., collecting, receiving, transmitting, storing, processing, sharing, accessing, and/or modifying data objects) may desire to perform actions on the data objects in a centralized manner. This may involve having to discover and locate each of the data objects over the distributed computer system, classify the data objects into one or more meaningful, conceptual or logical classes or categories, and centrally apply policies and/or perform actions with respect to the data objects on an individual and/or class or category basis. As the system scales with more nodes or users, such a centralized functionality may help to enforce uniform security controls and policies across all nodes and platforms based on the logical or functional classification, regardless of data object type or storage location.

Accordingly, in some embodiments, the present technique provides for operationally connecting to a target computer system, to conduct an initial forensic scan to create an inventory of all data objects in the computer system. The forensic scan includes a systematic enumeration and inspection of data objects and their metadata across a target computing environment. In some embodiments, after the initial forensic scan, the present technique provides for continuous, recurrent or periodic forensic scans to update the created inventory with any changes to data objects in the computer system. In some embodiments, such continuous, recurrent or periodic forensic scans may be performed according to any desired to suitable schedule, for example, hourly, daily, weekly, bi-weekly, etc.

In some embodiments, the forensic scan comprises a data object discovery stage to discover, locate, catalog, and create an inventory and mapping of all data objects in the target computer system. In some embodiments, the data object discovery stage may be performed by a client application that is native to the target computer system. However, in other cases, the data object discovery stage may be performed by an external computer system (e.g., a data discovery system) which may operationally connect to the target computer system via a public or private data network, and deploy a client application to perform the data discovery process.

In some embodiments, the present technique then provides for collecting metadata and related information with respect to historic and current usage of data objects in computer system, including, but not limited to, data object type, location, owner, author, main contributor(s), data object access and modification permissions, object access instances history (including, e.g., count, frequency, recency, and time of access instances, accessing user, type of access instances-read/write/modify), and events associated with data access instances. In some embodiments, the present technique may be configured to collect the information with respect to usage of data objects in the created inventory continuously, recurringly or periodically, for example, hourly, daily, weekly, bi-weekly, etc.

In some embodiments, the present technique may then provide for classifying the discovered data objects within the target computing system into one or more meaningful classes or categories, based on any desired or suitable categorization schema. For example, data objects may be categorized on the basis of geographic location, storage type (e.g., on-premise, private cloud, public cloud, etc.), data object type, applicable regulatory regime, applicable privacy controls, etc., and/or any combination of these categories.

In one example, the present technique provides for classifying all data objects in a target distributed computing system, into classes or categories based on their predicted activity status. Accordingly, in some embodiments, the present technique provides for classifying each data object within the target computing system into a set of predetermined classes of data objects, based, at least in part, on categorizing each of the data objects according to its predicted activity status. In some embodiments, categorizing each of the data objects within the target computer system according to its predicted activity status is based on establishing a predicted activity status with respect to each of the data objects in the distributed computer system. In some embodiments, establishing a predicted activity status with respect to each of the data objects in the distributed computer system indicates the likelihood that any such data object will be used and/or accessed within a predefined time window, such as within the next hour, day, 7 days, 14 days, 30 days, or any other desired or suitable period of time.

In some embodiments, the steps of data object scan, discovery stage, metadata collection, and data object classification may be repeated continuously, recurringly or periodically, e.g., hourly, daily, weekly, bi-weekly, monthly, or according to any desired recurring schedule.

In some embodiments, the present technique then provides for real-time dynamic centralized graphical visualization of all data objects discovered, located and cataloged within the target computer system, according to their predicted activity status.

In some embodiments, the collected metadata and related information may be used to train a dedicated machine learning prediction model, to output a classification which indicates, with respect to each of the data objects in the computer system, the likelihood that such data object will be used and/or accessed within a predefined time window, e.g., within the next hour, day, 7 days, 14 days, 30 days, or any other desired or suitable period of time.

In some embodiments, the trained prediction model may be continuously, recurringly or periodically refined or re-trained using updated data object inventory and metadata collected continuously, recurringly or periodically with respect to the data objects in the computer system. In some embodiments, the classification model may be recalibrated by refining category boundaries based on observed access patterns, organizational changes, new projects, or system migrations.

In some embodiments, the prediction model is trained to output a binary classification (i.e., 0/1, or yes/no) which indicates, with respect to each of the data objects in the computer system, whether or not it is likely to be used and/or accessed within the predefined time window.

In other cases, the prediction model is trained to output a multi-class classification, which assigns each data object to of a set of predetermined classes. In one example, such set of classes may comprise, but is not limited to, the following classes:
Class I: Data object is active and likely to be accessed on a read/write/modify basis within the predefined time window. This prediction may indicate globally, with respect to all users of a data object, that the data object is active and is likely to be used and/or accessed within the predefined time window. Alternatively, this prediction may indicate separately, with respect to each user of a data object, whether the data object is active and likely to be used and/or accessed by such user within the predefined time window. Data objects included in this category are currently open files, recently modified objects, frequently queried database records, and data in active workflows. Active data typically requires the fastest storage media and lowest functional barriers to access.
Class II: This class may include moderately-active data that are accessed occasionally, such as recently completed projects, periodic reports, or seasonal business data.
Class III: This class may include data objects that are expected to be accessed on a read-only basis, and are not expected to be modified or edited by users.
Class IV: Inactive or infrequently accessed data with low probability of access in the near term. This class may include historical records, archived emails, or completed audit files.
Class V: Extremely rarely accessed data retained primarily for long-term preservation, legal holds, or compliance requirements.
Class VI: Data object is inactive, and is likely to be accessed only for periodic system maintenance or similar purposes within the predefined time window.

In some cases, the set of classes may include intermediate categories, and may be tailored to the need of specific organizations of industries.

In a typical enterprise computer system or environment, the trained prediction model is expected to classify between 24% of the total data objects in the computer system as ‘active’ i.e., data objects which are likely to be used and/or accessed on a read/write/modify, read-only or for maintenance purposes within the predefined time window. The trained prediction model is thus expected to classify the balance of the data objects in the computer system (between 96-98% of the total) as ‘inactive,’ i.e., as data objects which are unlikely to be used and/or accessed on a read/write/modify basis within the predefined time window.

In the case that the prediction model is trained to output a binary classification (i.e., 0/1, or yes/no), the balance of the data objects (between 96-98% of the total) will be classified as ‘inactive,’ i.e., as data objects which are unlikely to be used and/or accessed on a read/write/modify basis within the predefined time window.

In the case that the prediction model is trained to output a multi-class classification as per the example given immediately above, the balance of the data objects in the computer system, i.e., between 96-98% of the total, will be classified as one of, as the case may be: data object likely to be used and/or accessed on a read-only basis; data object unlikely to be used or accessed; and/or data object likely to be used and/or accessed for periodic system maintenance or similar purposes only.

In some embodiments, the present technique may then provide for caching those data objects classified as ‘active,’ i.e., likely to be used and/or accessed on a read/write/modify basis within the predefined time window, in a dedicate storage cache, that is secure, scanned for malware, and virtually air-gapped from the rest of the data. In some embodiments, the active data objects are made available for access over the predefined time window. In some embodiments, such data objects are made available for access using the standard login or permission protocols in use by the computer system.

In some embodiments, the secure cache may be an immutable storage which cannot be altered, deleted, or modified, to ensure data integrity and protection against threats like ransomware, accidental deletions, or malicious tampering. In some embodiments, the secure cache provides for tamper-proof storage which protects against unauthorized changes, including those by insiders or external threats like ransomware. In some embodiments, the secure cache may employ one or more of the following specific technologies and processes to ensure data integrity and protection:
Air-Gapped Storage: Data may be stored offline or in isolated environments to further protect against network-based attacks.
WORM Storage: Data may be stored in a WORM (write once, read many) format that ensures data can only be written once and cannot be altered or deleted after that initial write.
Data Object Lock: In cloud storage (e.g., AWS S3, Azure Blob Storage), an ‘object lock’ feature can enforce immutability by preventing changes or deletions to objects for a set period.
Encryption: Data may be encrypted to enhance security.

In some embodiments, the secure cache may be based, at least in part, on hardware-based solutions, such as tape storage with WORM capabilities or dedicated immutable cache appliances from vendors such as NetApp or Dell EMC. In some cases, the secure cache may be based, at least in part, on features and technologies offered by cloud provides, such as AWS S3 Object Lock, Azure Blob Storage Immutable Storage, Google Cloud Storage Lock, and the like. In other cases, the secure cache may be based, at least in part, on storage software solution, such as Veeam, Rubrik, Cohesity, Commvault, and the like.

The secure cache ensures that, in the event of a ransomware attack, critical active data objects remain accessible, thereby maintaining business continuity. Because the secure cache represents a small fraction of the total volume of data (e.g., 2-4%), it significantly reduces the resources required for data storage and backup, compared to traditional solutions. The relatively small size of the cache further allows measures that are difficult to implement when dealing with larger volumes of data-rigorous scanning against malware, reduced penetrability and attack surface, machine learning-based encryption testing, versioning in case of encryption suspicion, as well as frequent restore tests. The restore tests can be used to ensure the integrity and non-encrypted status of the cached data, as well as enable quick and efficient recovery exercises that are not feasible with larger data volumes typically associated with conventional backup systems.

In some embodiments, the present technique further provides for designating all other data objects, i.e., those classified as unlikely to be used and/or accessed on a read/write/modify basis within the predefined time window, as ‘inactive’ data objects (representing between 96-98% of the total volume of data). In some embodiments, data objects designated as inactive may be subject to enhanced security measures or protocols. For example, in some cases, a data object designated inactive may be subject to modified access protocols, which may require, for example, multi-factor authentication (MFA) to access the data object, or to have read and/or write privileges with respect to the data object. In some cases, a data object designated inactive may be designated as ‘read only,’ thereby eliminating write access to these data objects. Designating inactive data objects as ‘read only’ reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

In some embodiments, this classification schema is based on the insight that, after being generated and after an initial period of activity, data objects in a typical enterprise or similar computer system may become dormant or inactive, or otherwise infrequently accessed or used. At the same time, such data objects may be subject to ‘permission drift,’ where an increasing number of people are awarded or retain privileges with respect to the data object, where no actual business need exists for granting and maintaining such permissions. The existence of a very large pool of data objects with a wide permissioning base significantly increases the potential attack surface of the computer system.

Common cybersecurity tools have typically managed access control by focusing on identity management, that is, the identity of the individuals within the organization that are granted access to which file. However, identity-based access management requires an intricate and cumbersome process of identity, time, and geographic policy management. The complexity of managing identities and access rights is a well-documented challenge in the cybersecurity industry, and traditional systems often require extensive resources and constant oversight to maintain an accurate and secure access control framework.

Conversely, the present technique manages data object access on a time-based approach, built on the principle that access should be aligned with the needs and schedules of the data or resources in question. This means that permissions are dynamically modified day-to-day, based on a predicted need to use each data object, rather than based on the identity of the user. Thus, the present technique does not attempt to discern which user should be able to access any piece of data, but rather dynamically predicts, on an ongoing basis, whether the data object is actually likely to be accessed by any of its users. This proactive approach allows the system to adjust permissions and access rights in real-time, without the need for manual intervention by system administrators.

In some embodiments, the present technique then provides for continuously monitoring access-events with respect to all data objects in the computer system. Upon detecting an access-event, the present technique may provide for analyzing the access-event to determine an access-event score associated therewith. In some embodiments, access-event analysis may be based on one or more of the following access-event attributes:
Entity identity, including attributes, credentials, and unique identification information associated with an entity.
Entity access permissions and level of access with respect to a computer system and/or data objects within the computer system.
Entity past access and usage patterns with respect to the computer system and/or data objects within the computer system.
A total number of data objects accessed within a specified period of time (i.e., total number of data objects accessed, retrieved, read, modified, edited, moved, erased, received, transmitted, stored, processed, and/or shared). For example, the specified period of time may be, e.g., between 1-60 minutes, between 2-12 hours, between 1-7 days, etc. However, shorter, longer, or alternative time periods may be used.
Attributes of the one or more data objects accessed in the course of the access-event, including:
   Data object metadata, such as data object type, location, owner, author, main contributor(s),
   Data object access history, including, e.g., time of access, accessing entity, and/or type of access (read/write/modify).
   Data object security or sensitivity level.
   Data object predicted activity status, i.e., the predicted likelihood that a data object will be accessed within a specified next period of time.

In some embodiments, the present technique provides for continuously monitoring, detecting, and analyzing access-events within a computer system, to determine an access-event score associated with each access-event, based at least in part, on the access-event attributes defined with respect to the access-event.

In some embodiments, the present technique provides for one or more remedial actions, based on the access-event score associated with an access-event by an entity. The level of significance or sensitivity of an access-event is determined, at least in part, by the degree of confidence that a claim to a particular identity during authentication can be trusted to be the actual identity of the entity. Thus, when an access-event of elevated significance or sensitivity is detected, such access-event may negatively affect the degree of confidence, or “level of assurance,” in the identity of the entity. Accordingly, one or more remedial actions may be required to be taken in order to increase the level of assurance in the identity of the entity. The remedial actions may typically be designed to (i) contain and limit the extent of any potential damage from a potential malicious actor, and/or (ii) increase the level of assurance, e.g., by requiring one or more additional authentication factors to be supplied by the entity.

In some embodiments, the present technique provides for one or more automated remedial actions, based on the access-event score associated with an access-event by an entity. For example, upon detecting an access-event having a score which exceeds a predetermined threshold, one or more of the following remedial actions may be taken:
Data object-related actions: Actions associated with blocking or restricting the ability to access and/or modify one or more data objects. In some examples, the actions may comprise isolating, removing, quarantining, limiting access permissions, analyzing, and/or deactivating one or more of the data objects.
In some examples, actions associated with blocking or restricting the ability to access and/or modify one or more data objects, may apply to entire categories or classes of data objects, based on any desired or suitable categorization scheme which assigns data objects to one or more meaningful categories or classes. For example, data objects may be classified on the basis of geographic location, storage type (e.g., on-premise, private cloud, public cloud, etc.), data object type, applicable regulatory regime, applicable privacy controls, etc., and/or any combination of these categories.
In one example, data object-related remedial actions may involve implementing modified or enhanced access protocols with respect to one or more data objects, which may require, for example, one or more additional authentication factors to access or to have read and/or write privileges with respect to the data objects. In other cases, data object-related actions may involve designating one or more data objects as “read only.” In other cases, data object-related actions may involve segregating one or more data objects in a secure dedicated storage cache that is scanned for malware and is virtually air-gapped from the rest of the data.
Entity-related actions: Actions associated with revoking, restricting, or modifying the access and login privileges of one or more entities. In some cases, entity-related actions may involve modifying a level of authentication assurance associated with one or more entities, e.g., by requiring one or more additional authentication factors, e.g., two or more authentication factors.
Notifications: Actions associated with providing one or more notifications, such as sending an email, or generating an alert in one or more systems.

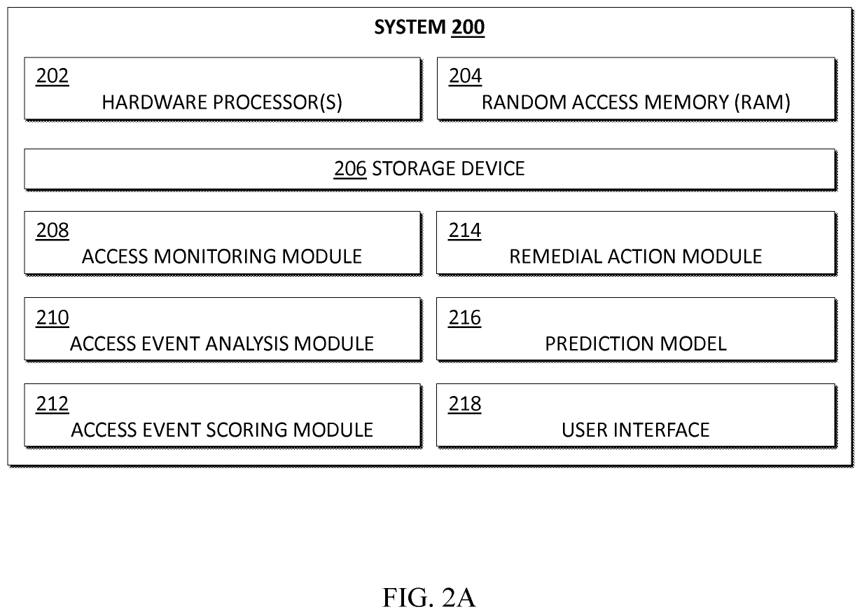

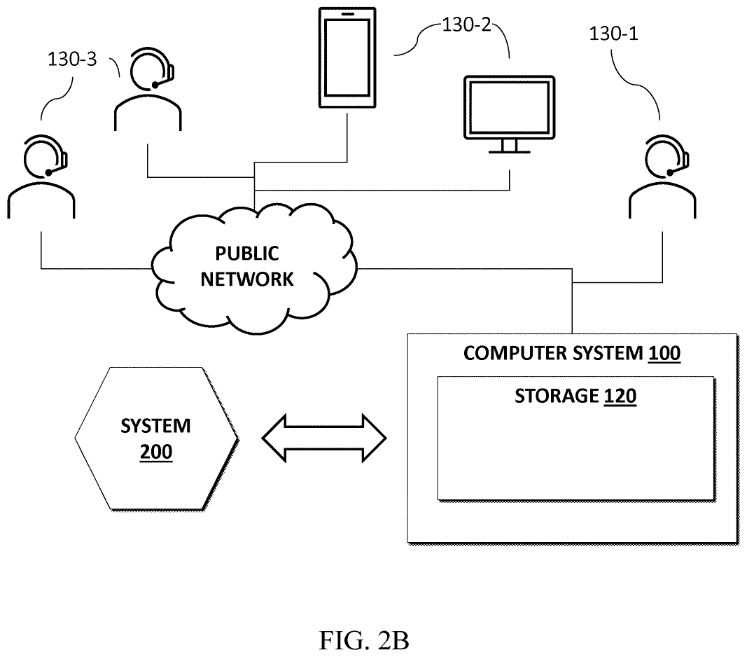

Reference is made to FIG. 2A, which is a block diagram of an exemplary system 200 for applying dynamic access controls in a computer system, based on analyzing access-events involving data objects in the computer system, according to some embodiments of the present disclosure.

In some embodiments, system 200 may comprise a hardware processor 202, a random-access memory (RAM) 204, and/or one or more non-transitory computer-readable storage device 206.

Processing module 202 may include components such as, but not limited to, one or more central processing units (CPUs), graphics processing units (GPUs), or any other suitable multi-purpose or specific processors or controllers. Processing module 202 may be operationally directly and/or indirectly connected to, and control the operation of, storage device 206 and all other components of system 200.

Storage device 206 may be or may include, for example, one or more non-transitory computer-readable storage device(s), a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

In some embodiments, system 200 may store in storage device 206 software instructions or components configured to operate a processing unit (also hardware processor, CPU, or simply processor), such as hardware processor 202. The software instructions may be any executable code, e.g., a software application, a program, a process, task or script. In some embodiments, the software instructions may include an operating system, including various software components and/or drivers for controlling and managing general system tasks (e.g., memory management, storage device control, power management, etc.) and facilitating communication between various hardware and software components.

System 200 may include one or more modules, such as an access monitoring module 208, an access-event analysis module 210, an access-event scoring module 212, a remedial action module 214, and/or a prediction model 216. These modules may constitute either software modules (e.g., code embodied on a machine-readable medium or in a transmission signal), hardware modules, or a combination of both hardware and software.

In some embodiments, system 200 may further comprise a user interface 218, comprising, e.g., a display monitor for displaying data and images, a control panel for controlling system 200, and/or a speaker for providing audio feedback.

System 200 as described herein is only an exemplary embodiment of the present invention, and in practice may be implemented in hardware only, software only, or a combination of both hardware and software. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Components of system 200 may be co-located or distributed, or the system may be configured to run as one or more cloud computing instances, containers, virtual machines, or other types of encapsulated software applications, as known in the art.

In some embodiments, system 200 may comprise one or more software applications and/or hardware components that are native to a distributed computer system environment, such as distributed computer system 100, and may be operable to perform the steps of one or more methods of the present technique described herein with respect thereto.

For example, system 200 may be realized as a client software application hosted on the target computer system and making use of its hardware and computational resources. In other cases, such as in the realization shown in FIG. 2B, system 200 is an external standalone computing system which may operationally connect to a target computing system, such as computer system 100, via a public data network, to perform the steps of one or more methods of the present technique described herein with respect thereto.

One or more entities may connect to computer system 100 directly and/or via a public data network. For example, user 130-1 is an entity which may connect and access computer system 100 directly, e.g., to any network, sub-network, or other portion of the larger computer system 100. In this example, user 130-1 may be an authorized user that validly logs in to computer system 100, which may be an enterprise computer system.

In another example, devices 130-2 and/or user 130-3 are entities which may connect to computer system 100 via a public network, such as the Internet. Devices 130-2 may comprise, for example, host devices and/or other devices such as mobile telephones, laptop computers, tablet computers, desktop computers or other types of computing devices. Devices 130-2 may provide computer services such as execution of one or more applications on behalf of one or more users associated with devices 130-2. Such applications may generate access requests or attempts that are processed by the computer system 100.

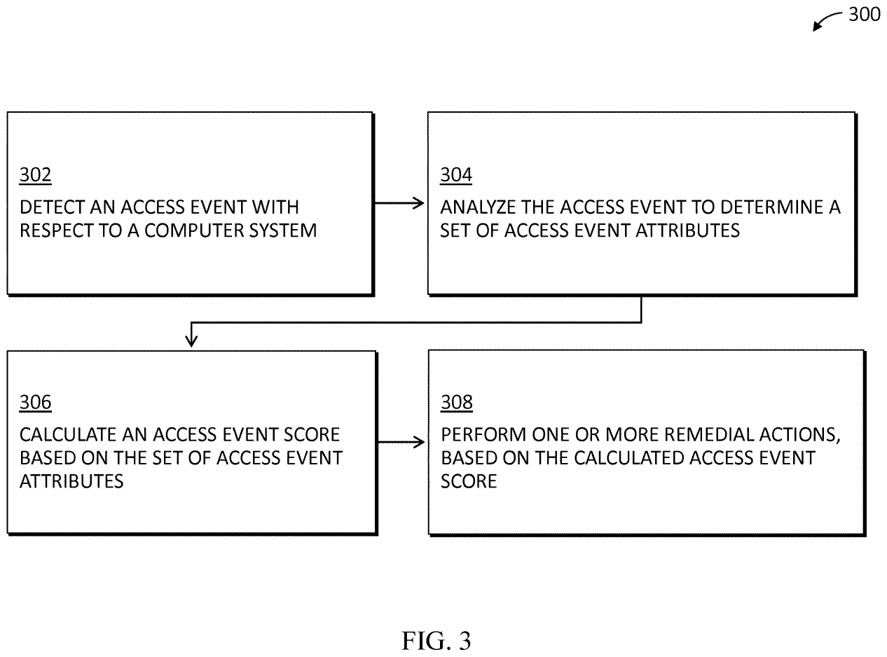

The instructions of exemplary system 200 will now be discussed with reference to the flowchart of FIG. 3 which illustrates the functional steps in a method 300 for dynamically applying access controls in a computer system, based on analyzing access-events involving data objects in the computer system, according to some embodiments of the present disclosure.

The various steps of method 300 will be described with continuous reference to exemplary system 200 shown in FIG. 2A and to the flowchart of FIG. 3.

The various steps of method 300 may either be performed in the order they are presented or in a different order (or even in parallel), as long as the order allows for a necessary input to a certain step to be obtained from an output of an earlier step. In addition, the steps of method 300 may be performed automatically and/or recursively (e.g., by system 200 of FIG. 2A), unless specifically stated otherwise.

Method 300 begins in step 302, wherein system 200 executes access monitoring module 208 to monitor access requests by entities in a target computer system or environment, to detect access events. In some embodiments, access monitoring module 208 continuously monitors access requests in real time. In other embodiments, access monitoring module 208 monitors access requests on a periodic or scheduled basis, or processes access request data in batch mode from stored access logs or audit trails.

The target computer system or environment may be any computing environment in which data objects are stored and accessed by entities, including, but not limited to: a distributed or decentralized computer system having multiple interconnected systems and storage locations over one or more private or public platforms; a standalone, non-distributed computer system; a hybrid computing environment comprising both on-premise and cloud-based infrastructure; a multi-cloud environment spanning two or more public cloud platforms; or a multi-tenant computing environment in which computing resources are shared among a plurality of tenants, each tenant having tenant-specific access policies and security configurations.

An example of a distributed computer system is computer system 100 depicted in FIG. 1A, comprising exemplary distributed storage 120 depicted in FIG. 1B. However, the present technique is not limited to distributed computing environments and may be implemented in any computer system in which entities access data objects.

In some embodiments, access monitoring module 208 monitors access requests using an event-driven architecture, wherein access requests generate event notifications that are intercepted by one or more listeners, hooks, or agents deployed within the target computer system. For example, access monitoring module 208 may deploy one or more lightweight monitoring agents within computer system 100, each agent configured to intercept and forward access request data from one or more storage nodes 122A-122N of distributed storage 120. In some embodiments, the monitoring agents intercept access requests at the operating system level (e.g., by hooking into file system calls, system call interfaces, or kernel-level audit frameworks), at the application level (e.g., by intercepting application programming interface (API) calls, database query requests, or application-layer events), or at the network level (e.g., by inspecting network traffic for access-related protocol messages).

In other embodiments, access monitoring module 208 monitors access requests by polling one or more access logs, audit trails, security event logs, or event streams at configurable intervals. The polling interval may be configured by an administrator and may range from sub-second intervals for high-sensitivity environments to hourly or daily intervals for lower-sensitivity or resource-constrained environments. In some embodiments, access monitoring module 208 subscribes to a message queue, event bus, or streaming data platform (e.g., a publish-subscribe messaging system) to receive access request notifications in near-real time.

In yet other embodiments, access monitoring module 208 receives access request notifications via an application programming interface (API) provided by the target computer system or by an external system integrated therewith, such as an identity and access management (IAM) platform, a security information and event management (STEM) system, a cloud access security broker (CASB), or a Zero Trust policy engine.

In some embodiments, access monitoring module 208 is configured to receive and process access request data from a plurality of heterogeneous data sources simultaneously, including operating system audit logs, application event logs, network flow data, API gateway logs, and authentication system logs.

In some embodiments, the scope of monitoring performed by access monitoring module 208 is configurable by an administrator or by the system itself based on policy rules. Monitoring may be scoped to, for example, one or more specified storage nodes, partitions, or geographic regions within distributed storage 120; one or more specified categories or classifications of data objects (e.g., monitoring only data objects classified as “confidential” or above); one or more specified entities or entity groups (e.g., monitoring access requests from entities in a particular organizational role, or from entities authenticated via a specific authentication method); one or more specified access types (e.g., monitoring only write, modify, delete, or export operations while permitting unmonitored read access to low-sensitivity objects); specified time windows (e.g., enhanced monitoring during non-business hours or during specified high-risk periods); or any combination thereof. In some embodiments, monitoring scope parameters are stored in a monitoring policy configuration accessible via user interface 218, and may be modified dynamically.

In some embodiments, the monitoring scope is dynamically adjusted by system 200 based on current system conditions, threat intelligence, or the results of prior access event analysis. For example, upon detecting an access event of elevated significance in step 306, system 200 may automatically expand the monitoring scope to include additional storage nodes, entity groups, or access types associated with the detected event, thereby providing adaptive, context-sensitive monitoring coverage.

The entity initiating an access request may be any entity as defined herein, including any authorized or unauthorized human, organization, automated bot, hardware device, software application, application programming interface (API) client, service account, automated script or agent, or any combination of such entities.

In some embodiments, the entity is logged in or authenticated to computer system 100 using one or more authentication mechanisms by which the entity identifies itself to computer system 100. Authentication mechanisms may include, but are not limited to any one or a combination of the following:
Single-factor authentication based on a knowledge factor, e.g., a username and password, a personal identification number (PIN), or a security question.
Multi-factor authentication (MFA) combining two or more of a knowledge factor, a possession factor (e.g., a mobile device, a hardware security token, a one-time password generator, or a smart card), and an inherence factor (e.g., a biometric identifier such as a fingerprint, facial recognition, iris scan, or voice pattern).
Token-based authentication using any suitable tokens.
In the case of non-human entities (e.g., API clients, service accounts, or automated scripts), authentication may be based on API keys, client certificates, shared secrets, or machine identity credentials.

In some embodiments, the authentication process assigns an initial authentication assurance level to the entity, representing the degree of confidence that the entity presenting the credentials is the entity to which the credentials were issued. The initial authentication assurance level may be determined based on one or more of the following factors:
Type and strength of authentication factors presented by the entity. For example, multi-factor authentication may receive a higher assurance level than single-factor password authentication.
Authentication protocol or method used.
Contextual factors associated with the authentication event, such as whether the entity authenticated from a recognized device, a trusted network location, a known geographic region, and/or during typical usage hours for the entity.
Recency and validity of the authentication session. For example, a recently authenticated session may receive a higher assurance level than a session that has been active for an extended period without re-authentication.
Entity's authentication history, including the frequency of failed authentication attempts, recent password or credential changes, or prior security incidents associated with the entity.

In some embodiments, the initial authentication assurance level is represented as a numerical value on a defined scale (e.g., a scale of 1 to 5, or a more granular scale of 1 to 100), as a categorical classification (e.g., low, medium, high, or very high assurance), or as a probability score. The initial authentication assurance level may be stored in association with the entity's active session.

In some embodiments, the entity initiates one or more access requests during an active session or connection to computer system 100. Each access request may comprise any action attempted or taken by the entity with respect to one or more data objects in computer system 100, including, but not limited to, any request or attempt to retrieve, read, query, modify, edit, copy, move, erase, execute, export, receive, transmit, store, process, share, or authenticate against one or more data objects. In the case of non-human entities, access requests may include, but are not limited to, API calls, database queries, batch processing operations, scheduled task executions, data pipeline operations, inter-service communications, and machine-to-machine data transfers.

In some embodiments, access monitoring module 208 generates, for each intercepted access request, a structured access request record comprising one or more of the following fields:
Entity identifier, such as a username, a service account name, an API client identifier, or a device identifier.
Session identifier associating the access request with an active authenticated session.
Timestamp indicating the time at which the access request was initiated.
One or more target data object identifiers, such as file paths, database table names, API endpoint identifiers, or resource URIs.
Access type indicator, such as read, write, modify, delete, execute, export, query, or share.
Source identifier indicating the origin of the access request, such as a source IP address, a device identifier, a geographic location derived from the source IP address, or an application identifier.
Protocol identifier indicating the access protocol used.
Contextual metadata, such as request payload size, response status, and the authentication assurance level associated with the entity's session at the time of the request.

In some embodiments, access monitoring module 208 performs one or mor processing operations on the structured access request records, to augment and enrich the raw access request data with additional contextual information, including, but is not limited to:
Supplementing entity identifiers against a directory service or identity provider to obtain entity attributes such as organizational role, department, group memberships, and employment status.
Supplementing data object metadata with attributes such as sensitivity classification, predicted activity status, owner, and storage location.
Resolving source IP addresses to geographic locations using a geolocation database.
Determining whether the source IP address, entity identifier, or access pattern is associated with known threats.
Determining whether the access request is consistent with the entity's typical usage patterns.

In some embodiments, access monitoring module 208 detects access events by evaluating incoming access requests, individually or in aggregation, against one or more detection rules and criteria, including, but not limited to:
Access frequency: Based on a number of access requests by an entity within a specified time window, such as more than 50 access requests within a 60-second period.
Access scope: Access requests are directed to data objects outside the entity's typical access scope, organizational unit, or permission boundary.
Access timing: Access requests occur outside of normal business hours for the entity, during weekends or holidays, or during time periods not associated with the entity's historical access patterns.
Access sensitivity: Access requests are directed at data objects having a security or sensitivity classification above a specified level, or at data objects classified as “inactive” or “routine maintenance” based on their predicted activity status.
Access velocity: Access requests rate by an entity exceeds a baseline rate derived from the entity's historical access profile by more than a configurable threshold.
Access location: Access requests originate from a geographic location that is inconsistent with the entity's known location or recent access history.
Access boundary: Access requests span multiple storage nodes, geographic regions, or data object categories in a pattern inconsistent with the entity's typical access scope.
Behavioral metrics: Behavioral deviation metrics quantifying a degree of deviation of the access event from a historical usage profile of the entity.

The detection rules may be configured by an administrator via a policy interface accessible through user interface 218, or may be dynamically adjusted by system 200 based on observed access patterns, current threat levels, or the results of prior access event analysis.

In some embodiments, an access event may be detected based on a single access request that satisfies one or more detection criteria, or based on an aggregation of multiple access requests that collectively satisfy one or more detection criteria when evaluated together. Aggregation may be based on one or more of:
Temporal proximity: Access requests occurring within a defined time window.
Session association: Access requests associated with the same authenticated session.
Entity identity: Access requests initiated by the same entity.
Target identity: Access requests directed at the same data object, the same category of data objects, or data objects within the same storage node or geographic region.

In some embodiments, access monitoring module 208 detects access events by applying a trained machine-learning detection model to incoming access request data or to the enriched structured access request records. The machine-learning detection model may be trained on historical access request data labeled with indicators of whether the access request or group of access requests was associated with an event of interest (e.g., a security incident, an anomalous access pattern, a data exfiltration attempt, or a policy violation). The machine-learning detection model may output, for each incoming access request or group of access requests, a probability or classification indicating whether the access request constitutes an access event warranting further analysis by access event analysis module 210 in step 304. In some embodiments, the machine-learning detection model is periodically retrained based on updated access request data and updated event labels, to adapt to evolving access patterns and emerging threat vectors.

In some embodiments, access monitoring module 208 applies a combination of rule-based detection and machine-learning-based detection, wherein rule-based detection provides baseline coverage for known threat patterns and policy violations, and machine-learning-based detection provides adaptive coverage for novel or evolving threat patterns that may not be captured by predefined rules. In some embodiments, rule-based detection and machine-learning-based detection operate in parallel, and an access event is detected if either the rule-based or the machine-learning-based detection mechanism identifies the access request or group of access requests as an access event.

In some embodiments, upon detecting an access event, access monitoring module 208 generates an access event record comprising, for each detected access event, the structured access request records associated with the access event and any additional contextual information derived from the log enrichment process. The access event record may further comprise an access event identifier uniquely identifying the access event, an indication of the detection criterion or criteria that triggered the access event, and a timestamp indicating the time at which the access event was detected. In some embodiments, the access event record is stored in an access event data store and is forwarded to access event analysis module 210 for analysis in step 304.

With reference back to FIG. 3, in step 304, system 200 executes access event analysis module 210 to analyze the access event detected in step 302, to determine a set of access event attributes associated with the access event. In some embodiments, access event analysis module 210 receives the access event record generated by access monitoring module 208, including the structured access request records and any additional data associated therewith. Access event analysis module 210 then extracts a set of access event attributes from the access event record. The set of access event attributes determined in step 304 serves as the input to access event scoring module 212 in step 306.

In some embodiments, access event analysis module 210 analyzes the detected access event to obtain a set of analytics based on one or more of the following categories of access event attributes:
Entity identification attributes.
Entity access permissions.
Entity authentication attributes.
Entity access and usage history.
Access event time-based attributes.
Access event scope.
Data object activity status.

Entity identification attributes: Attributes of the identity of the entity requesting or attempting access. These attributes may include entity credentials, such as a set of unique identifiers (e.g., a username, an entity identifier, a service account name, an API client identifier, or other personally identifiable information) that enables an entity to authenticate its identity.

In various embodiments, entity identification attributes may further include device-based attributes which may be uniquely associated with a device entity, such as a device name, a media access control (MAC) address, a device type, a hardware identifier, a firmware version executing on the device, a device vendor, trust and/or security attributes associated with the device, etc.

In various embodiments, entity identification attributes may further include software-based attributes which may be uniquely associated with a software application entity, such as application programming interface (API) information, an application name, an application vendor, version information, timestamps, security attributes, and/or operating systems supported by the application.

Entity access permissions: Attributes of the type of access that is granted to the entity within computer system 100, or with respect to one or more particular data objects within computer system 100. The entity permissions typically define what actions an entity may take with respect to a data object, including, but not limited to, read, modify, change owner, delete, execute, export, share, and the like.

For example, an unauthorized entity (i.e., an entity which is not a valid authorized user of computer system 100) may have no access permissions with respect to computer system 100 or any data objects therein. Conversely, an authorized entity (i.e., an entity which is a valid authorized user of computer system 100) may be granted access permissions, which may be entity-based or group-based within computer system 100. The permissions may attach to the entity itself as an authorized user of computer system 100. The permissions also may attach to a corresponding class of user entities, based on respective departments, roles, titles, locations, and the like within an organizational hierarchy.

In some embodiments, permissions may attach to data objects or classes of data objects, depending on the type and category of object. For example, the permissions that can be attached to a file are different from those that can be attached to a registry key or a database table. Permissions may also be based on an activity status of a data object, e.g., the predicted likelihood that a data object will be accessed within a specified period of time.

Entity authentication attributes: In some embodiments, access event analysis module 210 retrieves the current authentication assurance level associated with the entity's session, as established in step 302, and incorporates the authentication assurance level as an access event attribute. Access event analysis module 210 may further determine one or more authentication context attributes, including, but not limited to: the authentication method used by the entity (e.g., single-factor password, multi-factor authentication, certificate-based authentication, or token-based authentication); the time elapsed since the entity's most recent authentication or re-authentication event; the number and type of authentication factors presented; whether the authentication session is associated with a recognized device and network location; and whether the entity's authentication credentials have been flagged in any recent credential compromise databases or threat intelligence feeds.

Entity access and usage history: Past access and usage patterns by the entity with respect to computer system 100 and/or data objects within computer system 100. In some embodiments, access event analysis module 210 retrieves or computes entity usage profile information comprising one or more of the following usage pattern metrics:
Access frequency: Average number of access requests per hour, per day, or per week, over a trailing window of configurable duration.
Access duration: Typical duration of active sessions.
Access scope: Typical number of data objects accessed within a specified period of time, and/or typical number of data object categories accessed.
Access type distribution: The proportion of read-only, read/write, sharing, uploading, transferring, downloading, modifying, or deleting operations in the entity's historical access profile.
Data object type distribution: The categories of data objects typically accessed by the entity, such as systems, sub-systems, applications, databases, directories, data storage or repositories, storage devices, or websites.
Geographic access distribution: The storage node locations or geographic regions from which the entity typically accesses data objects.
Temporal access distribution: The times of day, days of week, and other temporal patterns associated with the entity's typical access activity.
Group baselines: The typical access patterns of entities having the same or similar organizational role, department, or group membership as the entity.

Access event time-based attributes: The access event time-based attributes include, but are not limited to:
Timing of the access event: Including, e.g., time of day, day of week, day of month, week of year, and/or whether the access event falls within or outside of the entity's typical active hours.
Duration of the access event: The elapsed time between the first and last access request within the access event, which may range from between 1-60 seconds, 1-60 minutes, 1-12 hours, 1-7 days, etc.
Time-based patterns: Whether the access event is consistent with or deviates from a recurring temporal pattern associated with the entity, such as a pattern of access every specified day of the week, between specified dates, every specified day of month, or every specified week of year.
Access velocity: The rate of access requests per unit time within the access event, and/or the rate of change in access request frequency over the duration of the access event.
Time since last access: The elapsed time since the entity's most recent prior access to the same data object or category of data objects.

Access event scope: The total number of data objects included in the access event. The total number of data objects may be defined as the number of data objects with respect to which access is attempted or requested by the entity within a specified period of time. In some cases, the total number of data objects may be further or alternatively defined on the basis of the total number of data objects within a specified category of data objects, with respect to which access is requested by the entity, such as, but not limited to: data object type (e.g., file, directory, database, data storage or repository, computer sub-system, external computer system, storage device, software program or application, website, user, group, end-device, server, network node, or storage node); data objects stored within a specified geographic location; data objects stored within a specified storage type (e.g., on-premise, private cloud, public cloud, or hybrid); and/or data objects associated with a specified sensitivity or regulatory classification.

Data object attributes: Attributes of the one or more data objects accessed in the course of the access event, including, but not limited to:
Data object metadata: Such as data object type, format, size, creation timestamp, last-modified timestamp, location within distributed storage 120, owner, author, and main contributor(s).
Data object access history: Including, e.g., time of last access, frequency of access over configurable time windows, identity of recently accessing entities, and/or type of access (read/write/modify/delete/export).
Data object security or sensitivity level: Data object indicated as public, internal, confidential, restricted, or a numerical sensitivity score.
Data object regulatory and compliance classification: Data objects subject to the one or more regulatory or compliance schemes, such as HIPAA, GDPR, etc.
Data object encryption status and key management attributes.
Data object version count and rate of recent modification.
Data object retention policy and expiration status.

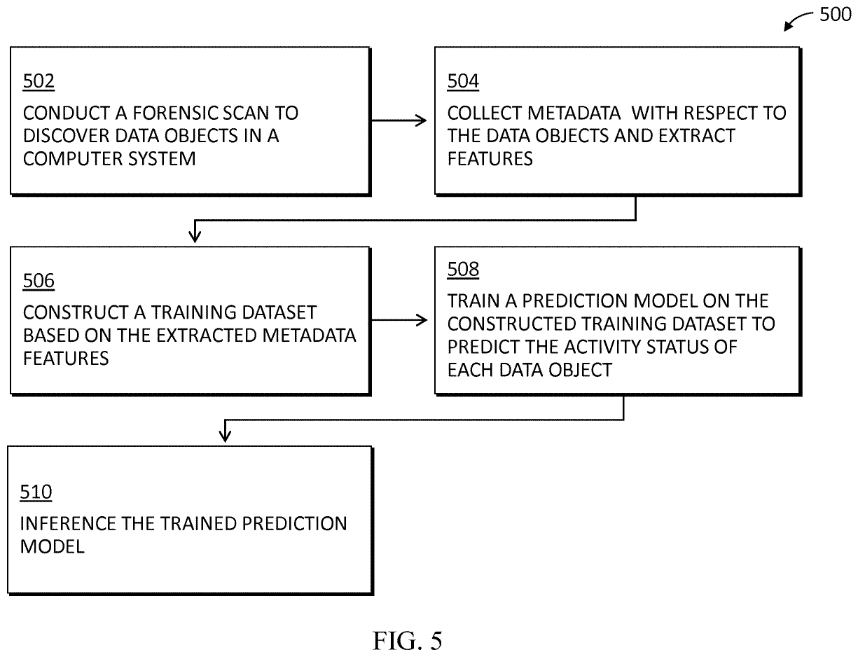

Data object activity status: The predicted likelihood that a data object accessed in the course of the access event will be accessed within the time period comprising the access event, as determined by prediction model 216 trained and inferenced in method 500 (FIG. 5). For example, the activity status of a data object may be indicated as one of the following classes:
Active data object: The data object is likely to be accessed on a read/write/modify basis within the time period comprising the access event.
Read-only data object: The data object is likely to be accessed on a read-only basis within the time period comprising the access event.
Inactive data object: The data object is unlikely to be used or accessed within the time period comprising the access event.
Routine maintenance: The data object is likely to be accessed for periodic or routine system maintenance only within the time period comprising the access event.

In some embodiments, the activity status of each data object is associated with a probability score output by prediction model 216, representing a confidence in the classification. The probability score may be used as a continuous input to the access event scoring algorithm in step 306, in addition to or instead of the discrete activity status class.

With reference back to FIG. 3, in step 306, system 200 executes access event scoring module 212 to calculate an access event score for the access event detected in step 302, based, at least in part, on the set of access event attributes determined in step 304. The access event score represents a significance level associated with the access event, wherein the significance level is determined, at least in part, based on a degree of confidence associated with the authentication of the entity by computer system 100. The access event score serves as the basis for determining whether and which remedial actions are to be performed in step 308.

In some embodiments, the access event score is represented as a numerical value on a defined scale. For example, the access event score may be represented on a scale of 1 to 100, where a value of 1 indicates the lowest level of significance or sensitivity and a value of 100 indicates the highest level of significance or sensitivity. In other embodiments, the access event score may be represented on a scale of 1 to 5, 1 to 10, or any other suitable numerical range. In another embodiment, the access event score may be represented as a binary indication (e.g., significant or non-significant). In yet another embodiment, the access event score may be represented as a discrete categorical classification (e.g., low significance, low-medium significance, medium significance, medium-high significance, or high significance). In some embodiments, the access event score may be represented as a composite score comprising both a numerical value and a categorical classification derived therefrom.

In some embodiments, access event scoring module 212 calculates the access event score as a weighted combination of a plurality of sub-scores, each sub-score corresponding to one or more categories of access event attributes determined in step 304. In one exemplary embodiment, the access event score is calculated according to the following weighted formula:

$$\begin{matrix}Score = {w}_{1} \times f ( entity score ) \\ + {w}_{2} \times f ( scope score ) \\ + {w}_{3} \times f ( temporal score ) \\ + {w}_{4} \times f ( object score ) \\ + {w}_{5} \times f ( activity status factor ) \\ + {w}_{6} \times f ( authentication factor )\end{matrix}$$

wherein:
Entity score is a sub-score derived from entity identification attributes, including the entity's authentication assurance level, credential risk indicators, and device trust status.
Scope factor is a sub-score derived from the access event scope and scope dispersion metric, reflecting the number and distribution of data objects accessed.
Temporal factor is a sub-score derived from the access event time-based attributes, reflecting the degree to which the timing, duration, and velocity of the access event deviate from the entity's historical temporal patterns.
Object score is a sub-score derived from data object attributes, including the security or sensitivity classification, regulatory compliance classification, and encryption status of the accessed data objects.
Activity status factor is a sub-score derived from the predicted activity status and associated probability scores of the accessed data objects, reflecting the degree to which the access event targets data objects that are not predicted to be accessed during the relevant time period.
Authentication factor is a sub-score derived from the authentication context attributes, including the current authentication assurance level associated with the entity's session, the recency of authentication, and the number and strength of authentication factors presented.
f( ) denotes a function that maps each sub-score to a common scale (e.g., 0 to 100).
Wₓ is a configurable weighting coefficient that determine the relative contribution of each sub-score to the composite access event score. The weighting coefficients may be configured by an administrator, determined by a machine-learning model, or dynamically adjusted based on current threat levels or policy configurations.

In one example, using a scale of 0 to 100 for the combined access event score:

| | | Value | | |
|---|---|---|---|---|
| Sub-Score | Attribute | (0-100) | Weight W | Score |
| Entity Score | Entity authenticated via | 65 | 0.15 | 9.75 |
| | single-factor password | | | |
| | from unrecognized device | | | |
| Scope Factor | Entity accessed 45 data | 72 | 0.20 | 14.40 |
| | objects across 3 storage | | | |
| | nodes in 10 minutes | | | |
| Temporal | Access occurred at 2:30 | 85 | 0.15 | 12.75 |
| Factor | AM on a Saturday | | | |
| Object Score | 30 of 45 data objects | 70 | 0.15 | 10.50 |
| | classified as “confidential” | | | |
| Activity | 38 of 45 data objects | 88 | 0.15 | 13.20 |
| Status Factor | classified as “inactive” | | | |
| Authentication | Authentication session | 60 | 0.10 | 6.00 |
| factor | active for 14 hours | | | |

| | |
|---|---|
| Combined Access Event Score | 66.60 |

In this example, the combined access event score of 66.60 exceeds the medium-high significance threshold (e.g., 61), triggering remedial actions as described in step 308.

In some embodiments, the activity status factor sub-score is determined based on the total number and proportion of data objects in the access event having each predicted activity status class. The activity status factor sub-score may be increased when the access event includes a higher number or proportion of data objects classified as “inactive” or “routine maintenance,” since access to such data objects by an entity during a period in which the data objects are not predicted to be accessed may indicate anomalous behavior.

For example, when an entity requests access to a small number (e.g., 1 to 4) of data objects classified as “inactive,” the activity status factor sub-score may be low (e.g., 10 to 25 on a 0-100 scale). When the entity requests access to a moderate number (e.g., 5 to 19) of data objects classified as “inactive” within a brief period of time, the activity status factor sub-score may be medium (e.g., 40 to 65). When the entity requests access to a large number (e.g., 20 or more) of data objects classified as “inactive” within a brief period of time, the activity status factor sub-score may be high (e.g., 75 to 100). In some embodiments, the activity status factor sub-score further incorporates the probability scores associated with the activity status predictions, such that data objects classified as “inactive” with high prediction confidence contribute more to the sub-score than data objects classified as “inactive” with low prediction confidence.

In some embodiments, access event scoring module 212 utilizes a trained machine-learning model to determine the access event score, as an alternative to or in combination with the weighted scoring formula described above. The machine-learning scoring model may be trained on training datasets comprising historical access event records, each record comprising a set of access event attributes as described in step 304, and labeled with a corresponding significance level or outcome indicator (e.g., whether the access event was subsequently determined to be associated with a security incident, a policy violation, or benign activity).

In some embodiments, the machine-learning scoring model may comprise any one or more suitable machine-learning algorithms, including, but not limited to: gradient boosting machines (e.g., XGBoost, LightGBM); random forests; deep neural networks (e.g., feedforward neural networks or recurrent neural networks configured to process sequences of access requests); support vector machines; or ensemble models combining two or more of the foregoing algorithms.

In some embodiments, the machine-learning scoring model is trained using a feature vector comprising the normalized sub-scores as input features, and the labeled significance level as the target variable. In other embodiments, the machine-learning scoring model is trained using the raw or derived access event attributes as input features, without the intermediate sub-score computation. In some embodiments, the machine-learning scoring model outputs a continuous probability score representing the predicted significance level, which is then mapped to the access event score scale.

In some embodiments, access event scoring module 212 uses a hybrid approach in which the weighted scoring formula provides a baseline access event score, and the machine-learning scoring model provides an adjustment or override based on patterns that may not be captured by the linear weighted formula, such as complex non-linear interactions among access event attributes.

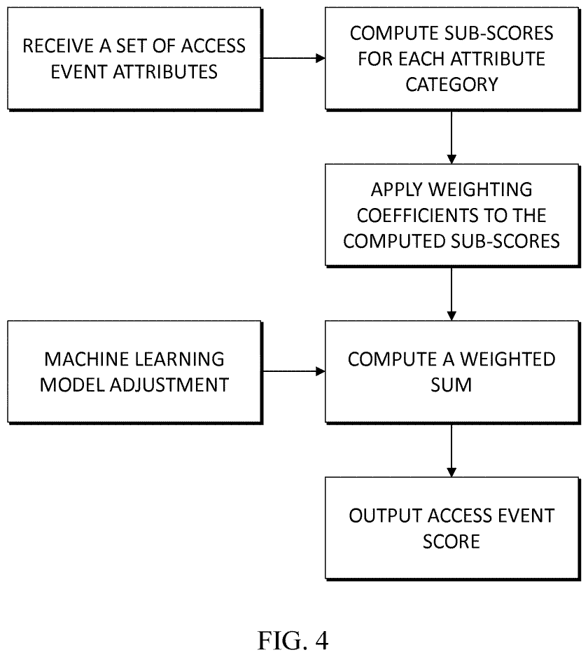

In some embodiments, the scoring algorithm implemented by access event scoring module 212 follows a decision flow as illustrated in FIG. 4.

With reference back to FIG. 3, in step 308, system 200 executes remedial action module 214 to perform one or more automated remedial actions, based on the access event score calculated in step 306. The remedial actions are designed to: (i) contain and limit the extent of any potential damage from a potential malicious actor; and/or (ii) increase the level of assurance in the identity of the entity, e.g., by requiring one or more additional authentication factors to be supplied by the entity.

In some embodiments, remedial action module 214 implements one or more of the following remedial actions:
Data-object technical remedial actions:
   Segregating one or more of the accessed data objects. The determination to segregate data objects may be based on their predicted activity status as determined by prediction model 216 trained and inferenced in method 500 (FIG. 5). For example, data objects classified as inactive or routine-maintenance by the prediction model may be segregated. The data objects may be segregated into a secure dedicated storage cache that is logically or physically air-gapped from the primary storage nodes, scanned for malware in real time, and configured with write-once-read-many (WORM) storage.
   Designating one or more accessed data objects as read-only. This may be performed at the storage-node level, by modifying the underlying file-system or object-storage ACLs and enforcing the restriction through the storage controller or hypervisor, thereby eliminating write, modify, delete, or export capabilities for the duration of the elevated risk period.
   Dynamically re-encrypting one or more accessed data objects with a higher-strength encryption key or rotating the existing key, and updating the key-management service to require re-authentication for decryption.
   Initiating an automated integrity check and creating a forensic snapshot of the affected data objects on an immutable storage volume prior to applying any restriction.
Entity-related technical remedial actions:
   Modifying the authentication assurance level associated with the entity's session and requiring step-up authentication, wherein the entity must present one or more additional factors (e.g., biometric verification, hardware security token, or cryptographic challenge-response) before any further access requests are granted.
   Suspending the entity's active session, revoking all associated authentication tokens or API keys, and forcing re-authentication through a hardened authentication pathway.
   Temporarily narrowing the entity's permission scope by applying a just-in-time role-based or attribute-based access control overlay that limits the entity to only those storage nodes or data-object categories that match its historical usage profile.
System-wide technical remedial actions:
   Expanding the monitoring scope in real time to include additional storage nodes, data-object categories, or entity groups associated with the detected access event.
   Triggering an automated adjustment of storage-node replication policies to create additional immutable replicas of affected data objects in isolated zones.

In some embodiments, remedial action module 214 implements a graduated escalation framework, wherein the type, number, and severity of remedial actions are determined based on the access event score and the corresponding significance category. In one exemplary embodiment, the graduated escalation framework comprises the following levels of significance:
Level 1 (access event score 0-30 on 0-100 scale): No action (access event score 0 to 30):* The access event is assessed as low significance. No remedial action is taken.
Level 2 (access event score 31-50): The access event is assessed as low-to-medium significance. Remedial actions may include increasing the logging detail level for subsequent access requests by the entity during the current session; expanding the monitoring scope for the entity's session (e.g., monitoring additional data object categories or storage nodes associated with the entity's access); and/or flagging the entity's session for enhanced scrutiny by access monitoring module 208.
Level 3 (access event score 51-70): The access event is assessed as medium significance. Remedial actions may include all Level 2 actions plus one or more of the following: generating an alert notification to one or more system administrators or security analysts; restricting the entity's access to data objects having a sensitivity classification above a specified level; designating one or more data objects involved in the access event as “read only” for the entity; and/or reducing the entity's authentication assurance level.
Level 4 (access event score 71-90): The access event is assessed as medium-high significance. Remedial actions may include all Level 3 actions, plus requiring the entity to perform step-up authentication by presenting one or more additional authentication factors before being permitted to continue accessing data objects. The additional authentication factors may include, but are not limited to: proof of possession of a specific device; a biometric factor; or a challenge-response verification.
Level 5 (access event score 91-100): The access event is assessed as high significance. Remedial actions may include all Level 4 actions, plus one or more of the following: quarantining or isolating one or more data objects involved in the access event by segregating the data objects in a secure dedicated storage cache that is scanned for malware and is logically or physically air-gapped from the remainder of computer system 100; suspending the entity's session and revoking the entity's active authentication tokens; locking the entity's account pending review by a security administrator; initiating an automated forensic scan of the data objects involved in the access event to detect evidence of unauthorized modification, exfiltration, or corruption; and/or preserving a forensic snapshot of the access event record, the entity's session state, and the state of the affected data objects for post-incident analysis.

The threshold values delineating Levels 1 through 5, and the specific remedial actions assigned to each level, may be configured by an administrator via a remedial action policy configuration accessible through user interface 218, and may be dynamically adjusted by system 200 based on current threat levels, organizational security policy changes, or the results of post-incident analysis. The foregoing five-level framework is exemplary only, and system 200 may implement fewer, additional, or alternative levels with different threshold values and remedial action assignments.

In some embodiments, the remedial actions performed in step 308 include one or more data object-related actions associated with blocking, restricting, or modifying the ability to access and/or modify one or more data objects. Data object-related remedial actions may include, but are not limited to:
Isolating, removing, quarantining, or air-gapping one or more data objects from the remainder of computer system 100.
Designating one or more data objects as “read only,” thereby preventing modification, deletion, or export of the data objects.
Limiting, revoking, or modifying access permissions associated with one or more data objects.
Requiring one or more additional authentication factors to access, read, modify, or export one or more data objects.
Encrypting one or more data objects with enhanced encryption or with additional key management controls.
Creating a forensic backup or snapshot of one or more data objects prior to restricting access, to preserve evidence.
Initiating an automated integrity scan of one or more data objects to detect unauthorized modifications.

In some embodiments, data object-related remedial actions apply to entire categories or classes of data objects, based on any desired or suitable categorization scheme which assigns data objects to one or more meaningful categories or classes. For example, data objects may be classified on the basis of geographic location, storage type (e.g., on-premise, private cloud, or public cloud), data object type, applicable regulatory regime, applicable privacy controls, predicted activity status, sensitivity classification, or any combination thereof. Accordingly, when a remedial action is triggered with respect to a data object belonging to a particular category, system 200 may apply the same or similar remedial action to all data objects within the same category, to contain the potential impact of the detected anomaly across the category as a whole.

In some embodiments, the remedial actions performed in step 308 include one or more entity-related actions associated with revoking, restricting, or modifying the access and login privileges of one or more entities involved in the access event. Entity-related remedial actions may include, but are not limited to:
Modifying the authentication assurance level associated with the entity, thereby requiring a higher level of identity verification for continued access.
Requiring the entity to perform step-up authentication by presenting one or more additional authentication factors, including proof of possession of a specific device, a security token or one-time password, or one or more biometric factors.
Reducing the entity's session timeout duration, requiring more frequent re-authentication.
Restricting the entity's access scope (e.g., limiting the entity to accessing only data objects within the entity's primary organizational unit or role-based access scope).
Suspending or terminating the entity's active session.
Locking, disabling, or suspending the entity's account pending administrative review.
In the case of non-human entities (e.g., API clients, service accounts, or automated scripts), revoking or rotating API keys, tokens, or client certificates associated with the entity.

In some embodiments, the remedial actions performed in step 308 include one or more notification and alerting actions, including, but not limited to:
Generating an alert in one or more security information and event management (STEM) systems, security operations center (SOC) dashboards, or other security monitoring platforms integrated with system 200.
Sending an email, instant message, or push notification to one or more designated system administrators, security analysts, or incident response personnel.
Creating an incident record in a ticketing or incident management system.
Updating the centralized graphical visualization dashboard described with respect to user interface 218, to display the detected access event, its score, the affected data objects, and the remedial actions taken.
Transmitting an event notification to an external system via an API or standardized event format (e.g., Common Event Format (CEF), STIX, or a JSON-based event schema) for correlation with events detected by other security systems.

In some embodiments, the remedial actions performed in step 308 generate feedback data that is incorporated into subsequent iterations of steps 302 through 308, creating a continuous feedback loop. For example, when step-up authentication is required in step 308 and the entity successfully presents the required additional authentication factors, the entity's authentication assurance level may be restored or increased, which may reduce the access event scores for subsequent access events by the same entity during the same or a subsequent session. Conversely, when the entity fails to present the required additional authentication factors, or when the entity's response to a step-up authentication challenge is inconsistent with expected behavior, the entity's authentication assurance level may be further reduced, potentially triggering higher-tier remedial actions for subsequent access events.

In some embodiments, the outcomes of remedial actions (e.g., successful step-up authentication, failed step-up authentication, continued anomalous access after remediation, or cessation of anomalous access after remediation) are logged and used as training data for the machine-learning scoring model described in step 306, enabling the scoring model to learn from the effectiveness of prior remedial actions and to refine future access event scores accordingly.

The instructions of system 200 will now be further discussed with reference to the flowchart of FIG. 5, which illustrates the functional steps in a method 500 for training and inferencing a prediction model configured to classify data objects in a distributed computer environment according to their predicted activity status.

The various steps of method 500 will be described with continuous reference to exemplary system 200 shown in FIG. 2A, and to the block diagrams of FIGS. 6A-6B, which provide an overview of a pipeline for training, inferencing, and updating of a prediction model of the present technique.

The various steps of method 500 may either be performed in the order they are presented or in a different order (or even in parallel), as long as the order allows for a necessary input to a certain step to be obtained from an output of an earlier step. In addition, the steps of method 500 may be performed automatically (e.g., by system 200 of FIG. 2A), unless specifically stated otherwise.

The instructions of system 200 will now be further discussed with reference to the flowchart of FIG. 3B, which illustrates the functional steps in a method 500 for training and inferencing a prediction model for classifying data objects in a target computer system according to their predicted activity status. As described with respect to step 304, the predicted activity status of data objects accessed in the course of an access event serves as an input to the access event scoring algorithm in step 306, via the activity status factor sub-score. Method 500 may be performed by system 200 independently of, concurrently with, or as a precursor to method 300.

In some embodiments, method 500 comprises the following principal stages:
(i) Step 502: Forensic scanning and data object discovery.
(ii) step 504: Metadata collection and feature engineering.
(iii) Step 506: Training dataset construction.
(iv) Step 508: Prediction model training and validation.
(v) Step 510: Prediction model inference and classification.

Method 500 begins in step 502, wherein system 200 executes a forensic scan of a target computer system or environment, such as computer system 100, to discover, locate, and inventory all data objects therein. The target computer system or environment may be any computing environment as described with respect to step 302, including a distributed or decentralized computer system, a standalone computer system, a hybrid computing environment, a multi-cloud environment, or a multi-tenant computing environment. In some embodiments, the forensic scan of step 502 is performed by a data discovery module or sub-module of system 200, which may be a component of prediction model 216 or a separate module configured to interface with prediction model 216.

In some embodiments, system 200 connects to data sources within the target computer system using one or more standard access protocols, including, but not limited to:
File system protocols, such as Server Message Block (SMB), Network File System (NFS), or Hadoop Distributed File System (HDFS).
Database protocols, such as Java Database Connectivity (JDBC), Open Database Connectivity (ODBC), or native database client protocols.
Cloud storage APIs, such as Amazon S3 API, Azure Blob Storage API, Google Cloud Storage API, or other cloud-provider-specific object storage APIs.
Application-layer APIs, such as REST APIs or GraphQL APIs.
Message queue or streaming protocols, such as Apache Kafka, Amazon Kinesis, or similar event streaming platforms.

In some embodiments, system 200 is configured to discover data objects across a plurality of heterogeneous data sources simultaneously, using protocol-specific connectors or adapters.

In some embodiments, system 200 performs the forensic scan by traversing the directory structures, namespaces, buckets, containers, databases, schemas, tables, and other organizational hierarchies of the target computer system to enumerate all data objects stored therein. In some embodiments, the forensic scan includes discovering data objects stored across multiple storage nodes 122A-122N of distributed storage 120, including data objects that are replicated across multiple storage nodes and data objects that are divided into portions according to an encoding scheme (e.g., erasure coding or sharding) and stored across two or more storage nodes.

In some embodiments, the scope of the forensic scan is configurable by an administrator or by system 200 based on policy rules. In some embodiments, the forensic scan operates in a full-scan mode, in which system 200 discovers and inventories all data objects within the configured scope, or an incremental-scan mode, in which system 200 discovers and inventories only data objects that have been created, modified, moved, or deleted since the most recent prior scan, using change detection mechanisms. In other cases, the forensic scan operates in a hybrid mode, in which system 200 performs periodic full scans at a lower frequency (e.g., weekly or monthly) and incremental scans at a higher frequency (e.g., hourly or daily) between full scans.

In some embodiments, system 200 generates a data object inventory comprising an entry for each data object discovered in the forensic scan. Each entry in the data object inventory may comprise a unique data object identifier, a data object type indicator, and one or more location references indicating the storage node(s), path(s), or other address(es) at which the data object is stored within the target computer system.

In some embodiments, system 200 stores the data object inventory in a persistent data store accessible by other modules of system 200, including access event analysis module 210 (which references the inventory during log enrichment in step 302 and access event attribute determination in step 304) and access event scoring module 212 (which references the inventory during scoring in step 306).

In some embodiments, system 200 supplements or replaces the forensic scan with data object discovery information obtained from one or more external asset management, data catalog, or configuration management database (CMDB) systems integrated with system 200. For example, system 200 may ingest data object inventory information from an enterprise data catalog (e.g., a metadata management platform), an IT asset management (ITAM) system, a cloud security posture management (CSPM) tool, or a data loss prevention (DLP) system, via a secure API, file-based import, or standardized integration protocol.

With reference back to FIG. 5, in step 504, system 200 collects and stores metadata with respect to each data object identified in the data object inventory generated in step 502. In some embodiments, the collected metadata comprises at least the following categories of metadata, as applicable with respect to each data object:
Data object identity metadata:
   Data object name. In some embodiments, the data object name is encoded using a natural language processing (NLP) method (e.g., a word embedding model, a sentence embedding model, or a character-level encoding model) to convert the textual data object name into a fixed-length numerical vector representation that preserves semantic similarity relationships among data object names while providing anonymization. In some embodiments, the encoding is performed using a pre-trained language model or a domain-specific embedding model fine-tuned on data object names within the target computer system.
   Data object type, e.g., file, directory, database table, database row, application data object, configuration file, log file, archive, container image, virtual machine snapshot, API endpoint definition, or other data object type as defined herein.
   Data object format and encoding, e.g., file format, compression type, encryption status, and character encoding.
   Data object size, e.g., in bytes, records, or other applicable unit of measurement.
   Data object creation timestamp and last-modified timestamp.
   Data object version count and version history summary, e.g., number of versions, frequency of version creation, and recency of the most recent version.
Data object location and distribution metadata:
   Location within distributed storage 120, e.g., storage node identifier, path, URI, bucket, namespace, schema, or partition.
   Geographic region or data center associated with the storage location.
   Replication metadata (e.g., number of replicas, locations of replicas, and replication policy).
   Encoding and distribution metadata.
   Tenant identifier (in multi-tenant environments).
Data object ownership and provenance metadata:
   Origin, e.g., source system, import pipeline, or creation context.
   Owner, e.g., the entity or organizational unit designated as the owner of the data object.
   Author, e.g., the entity that created the data object.
   Main contributors, e.g., entities that have made modifications to the data object, with contribution frequency and recency.
Data object access history metadata:
   Time of access, including time of day, day of week, day of month, week of year, and calendar date.
   Identity of the accessing entity, e.g., username, service account name, or API client identifier.
   Type of access, e.g., read, write, modify, delete, execute, export, share, query, or administrative access.
   Access frequency and recency metrics, e.g., total access count within configurable trailing windows, average access frequency, and time since most recent access.
   Session context of access, e.g., session identifier, session duration, and concurrent access by other entities during the same session.
Data object association metadata:
   Associated data objects, such as data objects with names that are semantically similar to the encoded representation of the data object name, as measured by Euclidean distance, cosine similarity, or other distance metric applied to the name embeddings; data objects referenced or linked by the data object; and data objects that are inputs to, outputs of, or dependencies within a shared data processing pipeline or workflow.
   Associated calendar events or scheduled tasks, scheduled backup or archival jobs, or routine maintenance operations referencing the data object.
Data object policy metadata:
   Data object permissions, e.g., access control lists, role-based access controls, and attribute-based access controls applicable to the data object.
   Security or sensitivity classification, e.g., public, internal, confidential, restricted, or a numerical sensitivity score.
   Regulatory and compliance classification, e.g., data objects subject to HIPAA, GDPR, etc.
   Retention policy and expiration status.
   Encryption status and key management attributes.

In some embodiments, system 200 applies one or more privacy-preserving techniques during metadata collection and storage, to protect the privacy of entities and to comply with applicable data protection regulations (e.g., GDPR, CCPA, or HIPAA). Privacy-preserving techniques may include, but are not limited to:
Anonymization and pseudonymization: Replacing entity identifiers anonymized or pseudonymized identifiers using hashing, tokenization, or k-anonymity techniques.
Data object name encoding: Encoding data object names using the NLP-based encoding described above, to convert potentially sensitive textual names into numerical vector representations that preserve semantic relationships without exposing the original names.

In some embodiments, system 200 performs feature engineering on the collected raw metadata to construct a feature vector for each data object. Feature engineering comprises transforming, deriving, encoding, normalizing, and selecting metadata attributes to produce a set of input features suitable for training the machine-learning prediction model in step 508. In some embodiments, feature engineering comprises one or more of the following operations:
Feature encoding: Converting categorical metadata attributes (e.g., data object name, type, access type, storage node identifier, etc.) into numerical representations
Temporal feature extraction: Deriving temporal features from access history timestamps, including, but not limited to: recency of last access (e.g., number of days since the most recent access); access frequency over multiple trailing windows of configurable duration (e.g., access count in the last 7 days, 14 days, 30 days, and 90 days); temporal regularity metrics (e.g., coefficient of variation of inter-access intervals, indicating whether the data object is accessed on a regular or irregular schedule); day-of-week and time-of-day distribution features (e.g., the proportion of accesses occurring on each day of the week, or during business hours vs. non-business hours); and trend features (e.g., whether the access frequency is increasing, stable, or declining over recent trailing windows).
Access pattern aggregation: Aggregating access history into data-object-level summary features, including: the number of distinct entities that have accessed the data object within a trailing window; the diversity of access types (e.g., whether the data object has been accessed for read, write, modify, and delete operations, or only for read operations); the concentration of access among entities (e.g., whether access is dominated by a single entity or distributed among many entities); and the recency and frequency of access by each of the data object's authorized users.
Association features: Deriving features from data object association metadata, including: the number and types of associated data objects; the access patterns of associated data objects (e.g., whether associated data objects have been recently accessed, which may predict that the current data object will also be accessed); and the presence or absence of scheduled events, maintenance windows, or pipeline executions associated with the data object within the prediction time window.

In some embodiments, system 200 performs feature selection to identify and retain the most informative features and to remove redundant or uninformative features from the feature vector, to improve model performance, reduce overfitting, and decrease inference latency. Feature selection techniques may include, but are not limited to: filter methods (e.g., selecting features based on statistical measures such as mutual information, chi-squared test, or correlation coefficient); wrapper methods (e.g., recursive feature elimination, forward selection, or backward elimination using model performance as the selection criterion); or embedded methods (e.g., L1 (Lasso) regularization, which drives uninformative feature weights toward zero during model training, or feature importance rankings derived from tree-based models).

With reference back to FIG. 5, in step 506, system 200 constructs a training dataset for a machine-learning classification model from the feature vectors produced in step 504. In some embodiments, the training dataset comprises, for each data object in the data object inventory, a feature vector representing the data object and its metadata as described in step 504, paired with a ground-truth label indicating the data object's observed activity status within a predefined time window.

In some embodiments, the ground-truth label for each data object is derived from observed access activity within a predefined time window following the metadata snapshot used to construct the feature vector. The predefined time window may be configurable and may be, for example, the next 7 days, 14 days, 21 days, 30 days, or any other shorter or longer desired period.

In one embodiment, the ground-truth label is a binary label indicating whether the data object was accessed by any authorized entity within the predefined time window (label=1 for “active,” label=0 for “inactive”).

In another embodiment, the ground-truth label is a multi-class label assigning one of the following activity-status classes to each data object, based on the type and pattern of observed access within the predefined time window:
Class I—Active: The data object was accessed on a read, write, modify, or other substantive basis within the predefined time window. In some embodiments, this label may be determined globally (with respect to all authorized entities) or separately for each authorized entity.
Class II—Inactive: The data object was not accessed by any authorized entity within the predefined time window.
Class III—Read-only: The data object was accessed, but only on a read-only basis (i.e., no write, modify, delete, or export operations) by any authorized entity within the predefined time window.
Class IV—Routine maintenance: The data object was accessed only for periodic or routine system maintenance purposes (e.g., by automated backup processes, archival jobs, integrity checks, or system service accounts) within the predefined time window, and was not accessed for substantive read or write purposes by any human or application entity.

In some cases, the set of classes may include intermediate categories, and may be tailored to the need of specific organizations of industries. For example, another exemplary multi-class label scheme may include the following classes:
Class I—Active: Data object is active and likely to be accessed on a read/write/modify basis within the predefined time window.
Class II—Moderately active: This class may include moderately-active data that are accessed occasionally, such as recently completed projects, periodic reports, or seasonal business data.
Class III—Read only: This class may include data objects that are expected to be accessed on a read-only basis, and are not expected to be modified or edited by users.
Class IV—Infrequently active: Infrequently accessed data with low probability of access in the near term. This class may include historical records, archived emails, or completed audit files.
Class V—Rarely active: Extremely rarely accessed data retained primarily for long-term preservation, legal holds, or compliance requirements.
Class VI—Inactive: Data object is inactive, and is likely to be accessed only for periodic system maintenance or similar purposes within the predefined time window.

In some embodiments, the training dataset is constructed on a per-entity basis, wherein each training example comprises a feature vector representing a (data object, entity) pair and a ground-truth label indicating whether the specific entity accessed the specific data object within the predefined time window. This per-entity variant enables prediction model 216 to generate entity-specific activity predictions (e.g., predicting whether entity A is likely to access data object X within the next 14 days), which may provide finer-grained input to the access event scoring algorithm in step 306.

In other embodiments, the training dataset is constructed on a global (data-object-level) basis, wherein each training example comprises a feature vector representing a data object (aggregated across all entities) and a ground-truth label indicating whether any authorized entity accessed the data object within the predefined time window. This global variant is less granular but requires fewer training examples and may be more practical in large-scale environments with many entities and data objects.

In step 508, system 200 trains a machine-learning prediction model on the training dataset constructed in step 506, to obtain a trained prediction model, which may be realized as prediction model 216. In some embodiments, prediction model 216 is trained to output, with respect to each data object in the target computer system, a classification indicating the predicted activity status of the data object within a predefined time window.

In some embodiments, the machine-learning prediction model may comprise any one or more suitable machine-learning algorithms, including, but not limited to:
Tree-based ensemble methods: Random Forest, Gradient Boosting Machines (e.g., XGBoost, LightGBM, or CatBoost), or Extra Trees classifiers.
Anomaly detection methods: Isolation Forest, One-Class Support Vector Machine (SVM), Local Outlier Factor (LOF), or Autoencoder-based anomaly detection, which may be used to identify data objects whose access patterns deviate significantly from expected patterns.
Neural network methods: Feedforward neural networks, recurrent neural networks (RNNs), long short-term memory (LSTM) networks, or transformer-based architectures configured to process sequential access history features. In some embodiments, neural network methods are particularly suited to capturing complex temporal dependencies in access history data.
Ensemble methods: Combinations of two or more of the foregoing algorithms, wherein the outputs of individual models are combined using voting, averaging, stacking, or blending techniques to produce a composite prediction.

In some embodiments, the model training process comprises the following stages: (i) loading the training partition of the training dataset; (ii) initializing the model with default or configured hyperparameters; (iii) iteratively fitting the model to the training data by minimizing a loss function (e.g., cross-entropy loss for multi-class classification, or binary cross-entropy loss for binary classification); (iv) evaluating model performance on the validation partition at configurable intervals during training; and (v) selecting the model checkpoint that achieves the best performance on the validation partition as the final trained model.

In one embodiment, prediction model 216 is trained to output a binary classification (i.e., 0/1, or yes/no) indicating, with respect to each data object, whether the data object is (i) “active,” i.e., likely to be accessed by an authorized entity within the predefined time window, or (ii) “inactive,” i.e., unlikely to be accessed by an authorized entity within the predefined time window. In some embodiments, the binary classification is determined by comparing the model's output probability score against a configurable decision threshold (e.g., 70%), wherein the data object is classified as “active” when the probability score exceeds the threshold and “inactive” when the probability score is below the threshold.

In another embodiment, prediction model 216 is trained to output a multi-class classification assigning one of the following activity-status classes to each data object:
Class I—Active: The data object is likely to be accessed on a read, write, or modify basis within the predefined time window. In some embodiments, this prediction is made globally (with respect to all authorized entities) or separately for each authorized entity.
Class II—Inactive: The data object is unlikely to be accessed by any authorized entity within the predefined time window.
Class III—Read-only: The data object is likely to be accessed on a read-only basis only within the predefined time window.
Class IV—Routine maintenance: The data object is likely to be accessed only for periodic or routine system maintenance within the predefined time window.

In another example, prediction model 216 is trained to output a multi-class classification assigning one of the following activity-status classes to each data object
Class I—Active: Data object is active and likely to be accessed on a read/write/modify basis within the predefined time window.
Class II—Moderately active: This class may include moderately-active data that are accessed occasionally, such as recently completed projects, periodic reports, or seasonal business data.
Class III—Read only: This class may include data objects that are expected to be accessed on a read-only basis, and are not expected to be modified or edited by users.
Class IV—Infrequently active: Infrequently accessed data with low probability of access in the near term. This class may include historical records, archived emails, or completed audit files.
Class V—Rarely active: Extremely rarely accessed data retained primarily for long-term preservation, legal holds, or compliance requirements.
Class VI—Inactive: Data object is inactive, and is likely to be accessed only for periodic system maintenance or similar purposes within the predefined time window.

In some embodiments, prediction model 216 outputs, for each data object, a probability score for each activity-status class, representing the model's confidence in each classification. The probability scores are stored in association with each data object's predicted activity status and are made available as a continuous input to the activity status factor sub-score computation in step 306.

In some embodiments, system 200 evaluates the performance of the trained prediction model on a validation dataset and/or the held-out test dataset using one or more classification performance metrics, including, but not limited to: accuracy (the proportion of data objects correctly classified); precision (the proportion of data objects predicted as a particular class that are correctly classified); recall (the proportion of data objects belonging to a particular class that are correctly identified); F1 score (the harmonic mean of precision and recall); area under the receiver operating characteristic curve (AUC-ROC); and area under the precision-recall curve (AUC-PR).

In step 510, system 200 applies the trained prediction model 216 to the data objects in the data object inventory to generate predicted activity-status classifications. In some embodiments, step 510 is performed after the initial training of prediction model 216 in step 506, and is re-performed periodically or on demand.

In some embodiments, the inference process comprises: (i) constructing a current feature vector for each data object using the most recently collected metadata and the feature engineering pipeline established in step 504, (ii) inputting the feature vector into the trained prediction model 216, and (iii) obtaining the predicted activity-status class and associated probability score(s) for each data object.

In some embodiments, system 200 performs inference in batch mode, generating predicted activity-status classifications for all data objects in the data object inventory in a single batch processing operation. In other embodiments, system 200 performs inference in near-real-time mode, generating or updating activity-status classifications for individual data objects or subsets of data objects in response to triggering events, such as: a new data object being added to the inventory; a significant change in a data object's metadata (e.g., a change in permissions, ownership, or access pattern); or a query from access event analysis module 210 during step 304, requesting the current predicted activity status for a specific data object involved in an access event.

In some embodiments, the predicted activity-status class and associated probability score(s) for each data object are accessible to access event analysis module 210 for use in determining the activity status data object attribute in step 304, and to access event scoring module 212 for use in computing the activity status factor sub-score in step 306.

In some embodiments, system 200 applies differential access controls to data objects based on their predicted activity-status classifications. Differential access controls may include, for example: applying stricter access controls (e.g., requiring multi-factor authentication, limiting access to a narrower set of authorized entities, or enabling enhanced monitoring) to data objects classified as “inactive” or “routine maintenance,” on the basis that access to such data objects during a period in which they are not predicted to be accessed may indicate anomalous or unauthorized activity; applying standard access controls to data objects classified as “active,” thereby reducing friction for legitimate access to data objects that are expected to be used; and applying read-only access controls to data objects classified as “read-only,” permitting read access while blocking write, modify, or delete operations.

In some embodiments, the differential access controls are applied as policy rules that are evaluated in conjunction with the access event scoring and remediation logic of method 300 (steps 302-308), such that the predicted activity status influences the access event score, which in turn determines the type and severity of remedial actions. In other embodiments, the differential access controls are applied independently of method 300, as standalone access policy rules that restrict or modify access permissions based on the predicted activity status.

In some embodiments, system 200 periodically collects updated metadata with respect to the data objects in the target computer system by re-executing the forensic scan and metadata collection procedures of steps 502 and 504. In some embodiments, the periodic metadata update is performed in incremental-scan mode, collecting metadata only for data objects that have been created, modified, or accessed since the most recent prior metadata collection. In other embodiments, the periodic metadata update is performed in full-scan mode at configurable intervals.

In some embodiments, the periodic metadata update further includes updating the data object inventory to reflect data objects that have been created, deleted, moved, or renamed since the most recent prior scan, and updating the stored metadata for existing data objects to reflect changes in access patterns, permissions, classification, or other metadata attributes.

In some embodiments, system 200 updates the training dataset constructed in step 504, based on the updated metadata, and retrains or updates prediction model 216 based on the updated training dataset.

In some embodiments, the retraining process comprises constructing new ground-truth labels based on observed access activity within a recent time window, updating the feature vectors with the most recently collected metadata, adding the new labeled examples to the training dataset, and retraining the model from scratch or performing incremental training using the updated dataset.

In some embodiments, metadata updating and model retraining are repeated periodically by system 200. The retraining frequency may be configurable and may be, for example, hourly, daily, weekly, bi-weekly, monthly, or any other desired interval. In some embodiments, the retraining frequency is determined dynamically by system 200 based on one or more of the following factors: the rate of change in access patterns within the target computer system (e.g., more frequent retraining when access patterns are changing rapidly); the observed degradation in model performance over time (e.g., triggering retraining when validation performance drops below a configurable threshold); the volume of new metadata available since the most recent retraining; or an administrative trigger initiated via user interface 218.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method for dynamically adjusting access controls in a computer system, the method comprising:
monitoring, by an access monitoring module executing on one or more processors, access requests by a plurality of entities in a target computer system comprising a plurality of data objects stored across one or more storage nodes, to detect an access event initiated by an entity;
analyzing, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window;
calculating, by an access event scoring module executing on the one or more processors, an access event score for the detected access event as a weighted combination of a plurality of sub-scores, each sub-score corresponding to one or more of said set of access event attribute categories, wherein the access event score represents a significance level of the access event; and
automatically performing, by a remedial action module executing on the one or more processors, one or more remedial actions based on the access event score, wherein the remedial actions include at least one technical modification to (i) an authentication method applicable to said entity, or (ii) access controls or storage configuration of one or more data objects in the distributed storage nodes.

2. The computer-implemented method of claim 1, wherein said machine-learning prediction model is trained on a training dataset comprising, for each of a plurality of data objects in the target computer system, (i) a feature vector derived from metadata collected in a forensic scan of the target computer system, and (ii) a ground-truth label indicating an observed activity status of the data object within a predefined time window, and wherein the trained machine-learning prediction model is periodically retrained based on updated metadata.

3. The computer-implemented method of claim 1, wherein the predicted activity status comprises one of the following activity-status classes: active, indicating the data object is likely to be accessed on a read, write, or modify basis within the predefined time window; inactive, indicating the data object is unlikely to be accessed within the predefined time window; read-only, indicating the data object is likely to be accessed on a read-only basis only within the predefined time window; or routine maintenance, indicating the data object is likely to be accessed only for periodic or routine system maintenance within the predefined time window

4. The computer-implemented method of claim 1, wherein detecting the access event comprises evaluating the access requests against one or more configurable detection rules, the detection rules comprising at least one of: a threshold condition based on a number of access requests within a specified time window; a scope condition based on the entity requesting access to data objects outside the entity's typical access scope; a temporal condition based on the time-related attributes of the access requests; a sensitivity condition based on the sensitivity or confidentiality attributes of the data objects associated with the access requests; a velocity condition based on a rate of access requests exceeding a baseline rate derived from the entity's historical access profile; a geographic condition based on the access requests originating from a geographic location inconsistent with the entity's known location; or a cross-boundary condition based on the access requests spanning multiple storage nodes, geographic regions, or tenant boundaries.

5. The computer-implemented method of claim 1, wherein detecting the access event comprises applying a trained machine-learning detection model to incoming access request data, the machine-learning detection model trained on historical access request data labeled with indicators of whether corresponding access requests were associated with a security incident, an anomalous access pattern, or a policy violation, wherein the machine-learning detection model outputs a probability or classification indicating whether the access requests constitute an access event.

6. The computer-implemented method of claim 1, wherein the remedial actions are selected from a plurality of remedial action levels, each remedial action level associated with a respective access event score range.

7. The computer-implemented method of claim 1, wherein the remedial actions comprise at least one of: (i) quarantining one or more data objects into a secure dedicated storage cache, (ii) designating one or more data objects as read-only, (iii) modifying the authentication assurance level associated with the entity representing a degree of confidence that the entity is an entity to which presented credentials were issued, (iv) modifying the authentication method applicable to the entity to include one or more additional authentication factors, (v) restricting access by the entity to one or more data objects, or (vi) suspending the entity's session.

8. The computer-implemented method of claim 1, wherein the set of access event attribute categories further comprises one or more of the following categories: entity access and usage history attributes, access event time-based attributes, access event scope attributes, and behavioral deviation metrics quantifying a degree of deviation of the access event from a historical usage profile of the entity.

9. A system comprising:
at least one hardware processor; and
a non-transitory computer-readable storage medium having stored thereon program instructions, the program instructions executable by the at least one hardware processor to:
monitor, by an access monitoring module executing on one or more processors, access requests by a plurality of entities in a target computer system comprising a plurality of data objects stored across one or more storage nodes, to detect an access event initiated by an entity,
analyze, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window,
calculate, by an access event scoring module executing on the one or more processors, an access event score for the detected access event as a weighted combination of a plurality of sub-scores, each sub-score corresponding to one or more of said set of access event attribute categories, wherein the access event score represents a significance level of the access event, and
automatically perform, by a remedial action module executing on the one or more processors, one or more remedial actions based on the access event score, wherein the remedial actions include at least one technical modification to (i) an authentication method applicable to said entity, or (ii) access controls or storage configuration of one or more data objects in the distributed storage nodes.

10. The system of claim 9, wherein said machine-learning prediction model is trained on a training dataset comprising, for each of a plurality of data objects in the target computer system, (i) a feature vector derived from metadata collected in a forensic scan of the target computer system, and (ii) a ground-truth label indicating an observed activity status of the data object within a predefined time window, and wherein the trained machine-learning prediction model is periodically retrained based on updated metadata.

11. The system of claim 9, wherein the predicted activity status comprises one of the following activity-status classes: active, indicating the data object is likely to be accessed on a read, write, or modify basis within the predefined time window; inactive, indicating the data object is unlikely to be accessed within the predefined time window; read-only, indicating the data object is likely to be accessed on a read-only basis only within the predefined time window; or routine maintenance, indicating the data object is likely to be accessed only for periodic or routine system maintenance within the predefined time window

12. The system of claim 9, wherein detecting the access event comprises evaluating the access requests against one or more configurable detection rules, the detection rules comprising at least one of: a threshold condition based on a number of access requests within a specified time window; a scope condition based on the entity requesting access to data objects outside the entity's typical access scope; a temporal condition based on the time-related attributes of the access requests; a sensitivity condition based on the sensitivity or confidentiality attributes of the data objects associated with the access requests; a velocity condition based on a rate of access requests exceeding a baseline rate derived from the entity's historical access profile; a geographic condition based on the access requests originating from a geographic location inconsistent with the entity's known location; or a cross-boundary condition based on the access requests spanning multiple storage nodes, geographic regions, or tenant boundaries.

13. The system of claim 9, wherein detecting the access event comprises applying a trained machine-learning detection model to incoming access request data, the machine-learning detection model trained on historical access request data labeled with indicators of whether corresponding access requests were associated with a security incident, an anomalous access pattern, or a policy violation, wherein the machine-learning detection model outputs a probability or classification indicating whether the access requests constitute an access event.

14. The system of claim 9, wherein the remedial actions comprise at least one of: (i) quarantining one or more data objects into a secure dedicated storage cache, (ii) designating one or more data objects as read-only, (iii) modifying the authentication assurance level associated with the entity representing a degree of confidence that the entity is an entity to which presented credentials were issued, (iv) modifying the authentication method applicable to the entity to include one or more additional authentication factors, (v) restricting access by the entity to one or more data objects, or (vi) suspending the entity's session.

15. A computer program product comprising a non-transitory computer-readable storage medium having program instructions embodied therewith, the program instructions executable by at least one hardware processor to:
monitor, by an access monitoring module executing on one or more processors, access requests by a plurality of entities in a target computer system comprising a plurality of data objects stored across one or more storage nodes, to detect an access event initiated by an entity;
analyze, by an access event analysis module executing on the one or more processors, the detected access event to determine a set of access event attribute categories, the set of access event attribute categories comprising at least: entity identification attributes comprising one or more attributes associated with the entity, data object attributes comprising one or more attributes associated with one or more data objects accessed in the course of the access event, and predicted activity attributes comprising a predicted activity status of at least one of the one or more data objects, the predicted activity status generated by a trained machine-learning prediction model and indicating a predicted likelihood that the data object will be accessed within a predefined time window;
calculate, by an access event scoring module executing on the one or more processors, an access event score for the detected access event as a weighted combination of a plurality of sub-scores, each sub-score corresponding to one or more of said set of access event attribute categories, wherein the access event score represents a significance level of the access event; and
automatically perform, by a remedial action module executing on the one or more processors, one or more remedial actions based on the access event score, wherein the remedial actions include at least one technical modification to (i) an authentication method applicable to said entity, or (ii) access controls or storage configuration of one or more data objects in the distributed storage nodes.

16. The computer program product of claim 15, wherein said machine-learning prediction model is trained on a training dataset comprising, for each of a plurality of data objects in the target computer system, (i) a feature vector derived from metadata collected in a forensic scan of the target computer system, and (ii) a ground-truth label indicating an observed activity status of the data object within a predefined time window, and wherein the trained machine-learning prediction model is periodically retrained based on updated metadata.

17. The computer program product of claim 15, wherein the predicted activity status comprises one of the following activity-status classes: active, indicating the data object is likely to be accessed on a read, write, or modify basis within the predefined time window; inactive, indicating the data object is unlikely to be accessed within the predefined time window; read-only, indicating the data object is likely to be accessed on a read-only basis only within the predefined time window; or routine maintenance, indicating the data object is likely to be accessed only for periodic or routine system maintenance within the predefined time window

18. The computer program product of claim 15, wherein detecting the access event comprises evaluating the access requests against one or more configurable detection rules, the detection rules comprising at least one of: a threshold condition based on a number of access requests within a specified time window; a scope condition based on the entity requesting access to data objects outside the entity's typical access scope; a temporal condition based on the time-related attributes of the access requests; a sensitivity condition based on the sensitivity or confidentiality attributes of the data objects associated with the access requests; a velocity condition based on a rate of access requests exceeding a baseline rate derived from the entity's historical access profile; a geographic condition based on the access requests originating from a geographic location inconsistent with the entity's known location; or a cross-boundary condition based on the access requests spanning multiple storage nodes, geographic regions, or tenant boundaries.

19. The computer program product of claim 15, wherein detecting the access event comprises applying a trained machine-learning detection model to incoming access request data, the machine-learning detection model trained on historical access request data labeled with indicators of whether corresponding access requests were associated with a security incident, an anomalous access pattern, or a policy violation, wherein the machine-learning detection model outputs a probability or classification indicating whether the access requests constitute an access event.

20. The computer program product of claim 15, wherein the remedial actions comprise at least one of: (i) quarantining one or more data objects into a secure dedicated storage cache, (ii) designating one or more data objects as read-only, (iii) modifying the authentication assurance level associated with the entity representing a degree of confidence that the entity is an entity to which presented credentials were issued, (iv) modifying the authentication method applicable to the entity to include one or more additional authentication factors, (v) restricting access by the entity to one or more data objects, or (vi) suspending the entity's session.
